(19) United States
(12) Patent Application Publication
(10) Pub. No.: US 2017/0173569 A1
(43) Pub. Date: Jun. 22, 2017

(54) Fe-ppm Pd, Cu and/or Ni Nanoparticle-Catalyzed Reactions in Water

(71) Applicants: Bruce H. Lipshutz, Santa Barbara, CA (US); Sachin Handa, Louisville, KY (US)

(72) Inventors: Bruce H. Lipshutz, Santa Barbara, CA (US); Sachin Handa, Louisville, KY (US)

(21) Appl. No.: 15/379,986

(22) Filed: Dec. 15, 2016

Related U.S. Application Data
(60) Provisional application No. 62/268,089, filed on Dec. 16, 2015.
(60) Provisional application No. 62/351,576, filed on Jun. 17, 2016.

(51) Int. Cl. B01J 23/89; C07B 31/00; B01J 37/00; B01J 23/745; B01J 35/00

(52) U.S. Cl. CPC B01J 23/8906; B01J 23/745; B01J 35/0013; B01J 37/009; C07B 31/00

(57) ABSTRACT

In one embodiment, the application discloses a composition for the reduction of an organic compound comprising a nitro group to form an organic compound comprising an amine group, the composition comprising: a) a transition metal salt; b) an iron salt; and c) a reducing agent; and methods for the use of such compositions, including Click chemistry and cross coupling reactions.

### RELATED APPLICATION

This application claims priority to U.S. Provisional Patent Application No. 62/268,089, filed on Dec. 16, 2015 and U.S. Provisional Patent Application No. 62/351,576, filed on Jun. 17, 2016.

### BACKGROUND OF THE INVENTION

Aromatic and heteroaromatic amines represent a class of indispensible intermediates in the course of preparing fine chemicals, bio-chemicals, and pharmaceuticals. Although, there are numerous synthetic pathways to generate such species, perhaps the most prominent among them relies on hydrogenation of nitro-containing compounds (Nishimura, S. Handbook of Heterogeneous Hydrogenation of Organic Synthesis, Wiley, New York, 2001) and catalytic C—N bond-forming processes. For selected reviews see: Hartwig, J. F. Acc. Chem. Res. 1998, 31, 852; Hartwig, J. F. Angew. Chem., Int. Ed. 1998, 37, 2046. Hydrogenations typically rely on precious-metal-catalyzed reductions (e.g., Pd, Au, Ru and alloys). Alternatively, earth-abundant metal-mediated reductions have been described using Zn, Co, Ni and Fe. Negishi, E. Handbook of Organopalladium Chemistry for Organic Synthesis, Volume 2; Tuteja, J. et al. RSC Adv. 2014, 4, 38241; Wang, P. et al. J. Catal. Sci. Technol. 2014, 4, 1333; Yamada, Y. M. et al. Angew. Chem. 2014, 53, 127; Choudhary, H. et al. J. Mater. Chem. A 2014, 2, 18687; Li, L. et al. ACS Nano 2014, 8, 5352. Ge, Q. et al. J. Appl. Poly. Sci. 2015, 132, 42005; Liu, X. et al. Angew. Chem., Int. Ed. 2014, 53, 7624. Oh, S. G. et al. J. Catal. Commun. 2014, 43, 79. Sabater, S. et al. ACS Catalysis 2014, 4, 2038; Goksu, H. et al. ACS Catalysis 2014, 4, 1777. Kelly, S. M.; Lipshutz, B. H. Org. Lett. 2014, 16, 98. Zhao, Z. et al. Green Chem. 2014,16, 1274. Mokhov, V. M. et al. Russ. General Chem. 2014, 84, 1515; Zamani, F. et al. Catal. Commun. 2014, 45, 1; Rathore, P. S. et al. Catal. Sci. Technol. 2015, 5, 286; Kalbasi, R. J. et al. RSC Adv. 2014, 4, 7444. Gao, G. et al. Green Chem. 2008,10, 439; Dey, R. et al. Chem. Commun. 2012, 48, 7982; Moghaddam, M. M. et al. Chem Sus Chem, 2014, 7, 3122; MacNair, A. J. et al. Org. Bio. Chem. 2014,12, 5082; Wang, L. et al. Synthesis 2003, 2001; Gu, X. et al. Chem. Commun. 2013, 49, 10088; Pehlivan, L. et al. Tetrahedron Lett. 2010, 51, 1939; Junge, K. et al. Chem. Commun. 2010, 46, 1769; Jagadeesh, R. V. et al. Chem. Commun. 2011, 47, 10972; Jagadeesh, R. V. et al. Science 2013, 342, 1073; Jagadeesh, R. V. et al. ACS Catal. 2015, 5, 1526.

Palladium catalyzed hydrogenation of nitro group is among the most widely used method: The development of highly active and reusable palladium catalysts has always been hot topics for that purpose. Usually, the level of palladium used remains at a percentage level, which may bring contamination to both product and environment. The environmentally benign nature and high natural abundance of iron, in particular, make it an ideal choice for nitro hydrogenation.

Early work focused on the stoichiometric iron-mediated reductions of nitro compounds under aqueous acidic conditions (Scheme 1). Subsequent iron-catalyzed hydrogenation under homogeneous conditions was reported by Thomas and others, although high catalyst loadings, excess reducing agent, and limited substrate scope limit this protocol. More recently, Beller et al. have presented a number of very efficient, heterogeneous nano-scale iron oxide-based net reductions under conditions that involve either H₂ at 50 bar, N₂H₄.H₂O, or HCOOH/Et₃N as the hydrogen source. Elevated reaction temperatures, and especially energy-intensive reagent preparation, may also place limitations on potential applications to otherwise highly functionalized, sensitive molecules.

Click chemistry is a class of versatile and highly efficient reactions that may be employed in the preparation of pharmaceuticals compounds and agricultural products. In particular, the Huisgen 1,3-dipolar cycloaddition reaction of azides and alkynes are particulary useful because of they are simple to perform under relatively simple reaction conditions, provide high regiospecificity and high reaction yields and provide high product purity. See for example, D. Wang et al, Pharm Res. 2008 October; 25 (10): 2216-2230; Spiteri, C. et al (2010) Angewandte Chemie International Edition, 49 (1) 31-33 and J. E. Moses et al. (2007), Chem. Soc. Rev 36 (8) 1249-4262.

Moreover, from the environmental perspective, both the Pd and Fe catalysis, use of organic solvents, especially water-miscible reaction media like THF, lead to large volumes of organic waste, further complicated by even larger amounts of waste water streams. Thus, opportunities remain for new chemistry that offers a solution to all of these issues: Simple reagent formation, broad substrate scope, low catalyst loadings, short reaction times and high efficiency, ambient temperature reaction conditions, catalyst recyclability, and the complete elimination of organic solvents from the reaction medium.

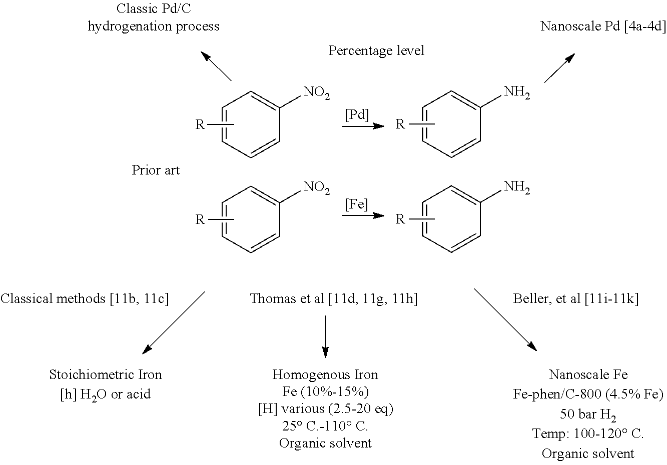

The Present Application:

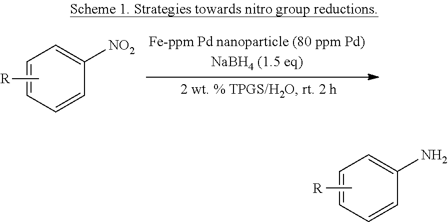

In our previous work, we described the origin and source of the iron salt, the presence of ppm levels of Pd, and the manner through which these are converted to nanoparticles. Handa, S.; Wang, Y.; Gallou, F.; Lipshutz, B. H. Science, 2015, 4, 1087. The present application discloses that the natural occurrence of the Fe source containing ppm levels of Pd may be the solution for all the above difficulties. And using similar nanoparticle methods of preparation, this chemistry may further benefit from the presence of nanomicelles that, by virtue of their PEG-ylated nature, deliver the substrate to the active metal. See Lipshutz, B. H.; Ghorai, S. Aldrichimica Acta, 2008, 41, 59.

In one embodiment, the present application discloses an effective, and green process for chemo-selective reductions of nitro compounds, such as aliphatic, aromatic and heteroaromatic nitro compounds, such as nitroarenes, of varying complexities. In one aspect of the process, the reaction may be conducted at room temperature (rt) in water. In another aspect, the combination of Fe-ppm Pd nanoparticles or the combination of Fe-ppm Ni nanoparticles, and micelles catalysis provides the activity that allow the use of low levels of recyclable metal.

Our previous Fe-ppm Pd nanoparticles were generated by reduction of commercial available FeCl₃ with MeMgCl (1 equiv) in THF at rt, followed by quenching with water and triturating with pentane (Science 2015, 349, 1087). The nanoparticles can be stored for a period of time and use directly in the nitro group reduction. However, use of 99.99% pure FeCl₃ only yielded traces of product. Also, we discovered that the results vary from different batches and sources of FeCl₃. After checking the potential trace amounts of metals, such as Pd, Ni and Cu, the pure FeCl₃-derived NPs that are doped with a small amount of Pd (ca. 80 ppm, although amounts can vary, typically from 20-1000 ppm) enabled a smooth reduction of nitro groups. This procedure was established as a replacement of the standard procedure that originally utilized FeCl₃ containing natural levels of Pd salts. IR analysis showed that metals are bound to THF, while TEM analysis indicated that the nano Fe-ppm Pd nanoparticles are well dispersed, forming spherical particles of varying size (FIG. 1). Analysis by XPS indicates that the content of iron is about 8.6%, although this may vary depending upon the accuracy of the Grignard used in their preparation.

The nature of the surfactant also affects the observed reactivity. Screening of surfactants using three different substrates (A, B and C) showed TPGS-750-M (2 wt %) as a preferred amphiphile in water, as it gave consistently the best results (see FIG. 2). Other surfactants, however, such as Triton X-100, in some cases can be used in place of TPGS-750-M (as with substrate A).

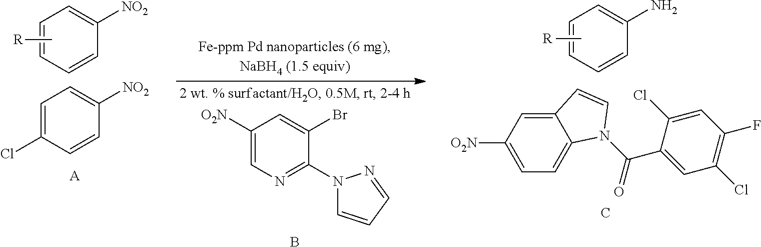

Other ionic surfactants, such as SDS, proved to be less effective for these reactions. The background reaction on water led to low levels of conversion even under prolonged reaction times. After significant screening of different hydride reagents, sodium borohydride was found to be surprisingly effective. Alternatively, KBH₄ (1-3 equiv) could be used for many substrates. Use of the combination of NaBH₄ and KCl (usually 1 equiv) was found to be effective. Reactions were best run under argon. While the loading of iron nanoparticles can be reduced to 1 mmol %, iron adherence to the reaction vial led to poor reproducibility (which may not be an issue at larger scale). It was discovered that the quantity of NaBH₄ could be lowered to 1-1.5 equivalents. This may reflect the far greater dissolution properties of gases (H₂ produced by NaBH₄) in organic media relative to water (see Young, C. L.; Hydrogen and Deuterium, Vol. 5/6 (Ed.: IUPAC Solubility Data Series), Pergamon, Oxford, England, 1981). Thus, higher concentrations of H₂ should be present inside the nanomicelles compared to the surrounding aqueous medium. For some substrates, especially structurally large compounds, a viscous precipitate may be observed during the reduction. In the case of Nimodipine, the addition of 2-3 drops of an organic solvent (e.g., pre-dissolve substrates in minimum amount of THF), along with lowering the concentration of substrates was found to increase the yield to 90%. It was discovered that the use of a co-solvent (e.g., THF, DMF, toluene, etc.), typically in the 1-10% range, oftentimes provides significantly better yields.

TABLE 2
Reduction for aryl nitro compounds^{a,b}

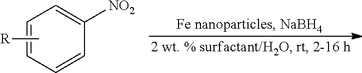

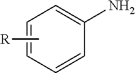

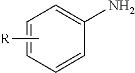

1 R = —Cl 90%
2 R = —CHO 76% ^{c}
3 R = —COOMe 93%
4 R = —COOH 80%
5 R = —CN 96%
6 R = —Br 88%
7 R = —I 66%
8 R = —SMe 94%

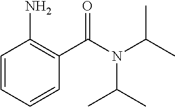 [SMILES: CC(C)N(C(=O)c1ccccc1N)C(C)C]

9 16 h, 90%

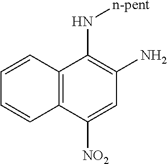

10 4 h, 70% ^{e}

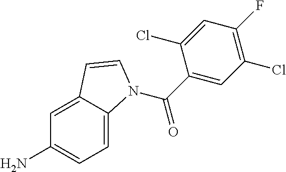 [SMILES: Nc1ccc2c(ccn2C(=O)c2cc(Cl)c(F)cc2Cl)c1]

11 2 h, 97%
2 h, 97%^{d}

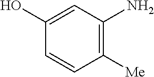

12 2h, 91%

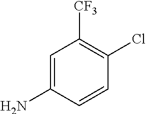 [SMILES: Nc1ccc(Cl)c(C(F)(F)F)c1]

13 2 h, 94%

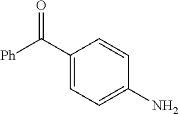 [SMILES: Nc1ccc(C(=O)c2ccccc2)cc1]

14 4 h, 82% ^{c}

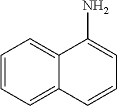 [SMILES: Nc1cccc2ccccc12]

15 2 h, 98%
2 h, 98%^{d}

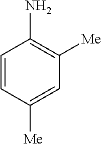

16 4 h, 94%

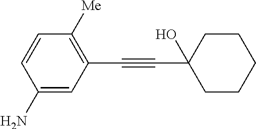 [SMILES: Cc1ccc(N)cc1C#CC1(O)CCCCC1]

17 1.5 h, 75% ^{c}

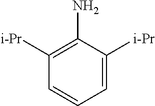 [SMILES: CC(C)c1cccc(C(C)C)c1N]

18 16 h, 88%

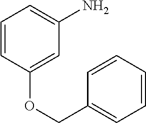 [SMILES: Nc1cccc(OCc2ccccc2)c1]

19 2 h, 90%

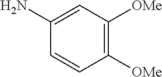 [SMILES: COc1ccc(N)cc1OC]

20 8 h, 93%

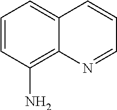 [SMILES: Nc1cccc2cccnc12]

21 2 h, 92%

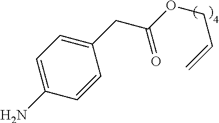

22 16 h, 87% ^{f}

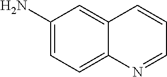 [SMILES: Nc1ccc2ncccc2c1]

23 2 h, 95%
2 h, 81%^{d}

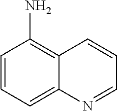 [SMILES: Nc1cccc2ncccc12]

24 2 h, 90%

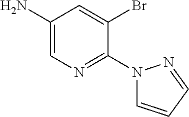 [SMILES: Nc1cnc(-n2cccn2)c(Br)c1]

25 4 h, 96% ^{e}
4 h, 94%^{d}

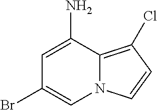 [SMILES: Nc1cc(Br)cn2ccc(Cl)c12]

26 16 h, 80%
16 h, 88%^{d}

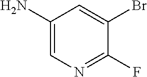

27 4 h, 98%

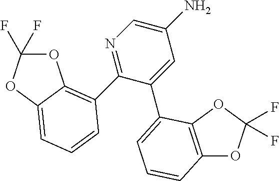 [SMILES: Nc1cnc(-c2cccc3c2OC(F)(F)O3)c(-c2cccc3c2OC(F)(F)O3)c1]

28 6 h, 82%
6 h, 83%^{d}

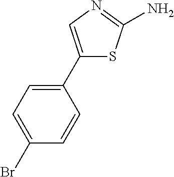 [SMILES: Nc1ncc(-c2ccc(Br)cc2)s1]

29 13 h, 93%

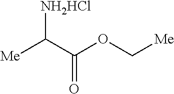

30 2 h, 91%
2 h, 93%^{d}

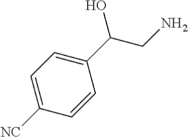 [SMILES: N#Cc1ccc(C(O)CN)cc1]

31 0.5 h 0%
(98%^{g})

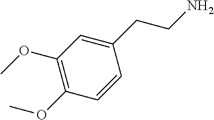

32 4 h, 82%

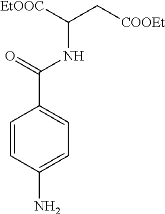 [SMILES: CCOC(=O)CC(NC(=O)c1ccc(N)cc1)C(=O)OCC]

33 6 h, 86% ^{e,f}

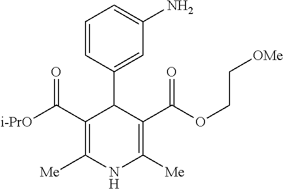

34 6 h, 90% ^{h}
6 h, 99%^{d,h}

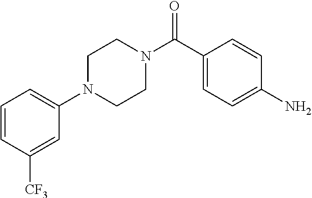 [SMILES: Nc1ccc(C(=O)N2CCN(c3cccc(C(F)(F)F)c3)CC2)cc1]

35 16 h, 82% ^{e,f}

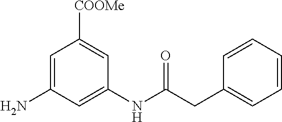 [SMILES: COC(=O)c1cc(N)cc(NC(=O)Cc2ccccc2)c1]

36 4 step synthesis, 80% ⁱ

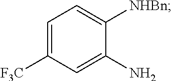

37 12 h, 80%

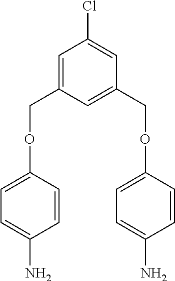 [SMILES: Nc1ccc(OCc2cc(Cl)cc(COc3ccc(N)cc3)c2)cc1]

38 18 h, 77% ^{e,f}
16 h, 82%

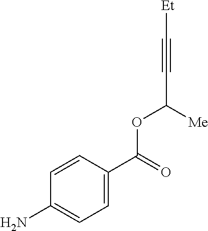 [SMILES: CCC#CC(C)OC(=O)c1ccc(N)cc1]

39 6 h, 90% ^{e,f}

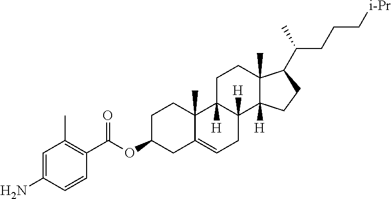

40 16 h, 79% ^{h}
^{a}Reaction conditions: Nitro compound (0.5 mmol, 1 equiv), Fe-ppm Pd nanoparticles (6 mg), NaBH₄ (0.75 mmol, 1.5 equiv), 2 wt. % TPGS-750-M/H₂O, 1 mL;
^{b} Isolated yield;
^{c} NaBH₄ (0.55 mmol, 1.1 equiv);
^{d}using standardized Fe-Pd (80 ppm) nanoparticle.
^{e} Fe nanoparticles (12 mg, 3.6%);
^{f} NaBH₄ (1.5 mmol, 3 equiv);
^{g}The yield of 4-(hydroxymethyl)benzonitrile;
^{h} Fe nanoparticles (12 mg), NaBH₄ (1.5 mmol, 3 equiv), addition of 0.1 mL THF;
ⁱsynthesized in four steps.

The process was demonstrated with a variety of substrates (Table 2). Several nitro arenes with substituents such as chloro, bromo, cyano, ester and methyl mercapto showed no variation in yield and chemo-selectivity. 4-Nitrobenzoic acid can also successfully reduced (product 4), which is a rare example of such a reduction in the presence of a free carboxylic acid. For 4-nitrobenzaldehyde and 1-iodo-4-nitrobenzene, competitive side reactions led to the decrease in yields (products 2, 7). The reduction may be performed with nitroarenes with various industrially or pharmaceutically important substituents (e.g., —CF₃, —F, —CN, —OH, etc.) in good to excellent yields with high chemoselectivity. Sterically demanding substrates, e.g. 9 and 18, required longer reaction times (16 h). Other sites of unsaturation were also well tolerated (e.g., —CN, —CHO, RCOR′, —C≡C, —C≡C, etc.). Heterocyclic nitro compounds may be reduced in both high yields and selectivities (see 11, 21, 23-29). Aliphatic nitro compounds, such ethyl 2-nitropropanoate and 1,2-dimethoxy-4-(2-nitroethyl) benzene, could also be reduced to the corresponding amines (products 30, 32).

From the pharmaceutical perspective, reductions of nitro-containing compounds that may lead to either bioactive or drug-like fragments using low levels of metal-based reagents is an important goal in synthesis. Representative compounds containing nitro groups that lead to the corresponding amino derivatives are illustrated in Table 2 (products 33-40). As an example, a multi-step synthesis of a potential Measles Virus inhibitor intermediate (product 36) was prepared with the corresponding benzoic acid as starting material via a four step synthesis. Sun, A. et al. J. Med. Chem. 2006, 49, 5080. Two steps of this four-step sequence can be effected in aqueous nanomicelles, thus avoiding reliance on organic solvents in each step. For comparison purposes, randomly selected substrates using standardized Fe-ppm Pd nanoparticles (doped with 80 ppm Pd as reaction) showed similar results. This doping method resolves the uncertainty problem of the levels of trace metal (Pd) in various sources of FeCl₃.

The residual palladium content in the product was found to be ≦10 ppm for the selected substrates (15, 26, 34). In previous work, we had shown that TPGS-750-M in water provides “nano reactors” in which a wide variety of reactions can take place. This process provides opportunities to effect tandem processes, in this case surrounding the formation of an amine in situ. As shown in Scheme 2, the aniline formed could be converted to its carbamate derivatives with standard protecting groups such as Boc (products 41 and 44), Fmoc (product 42), and Alloc (product 43) in the same aqueous mixture.

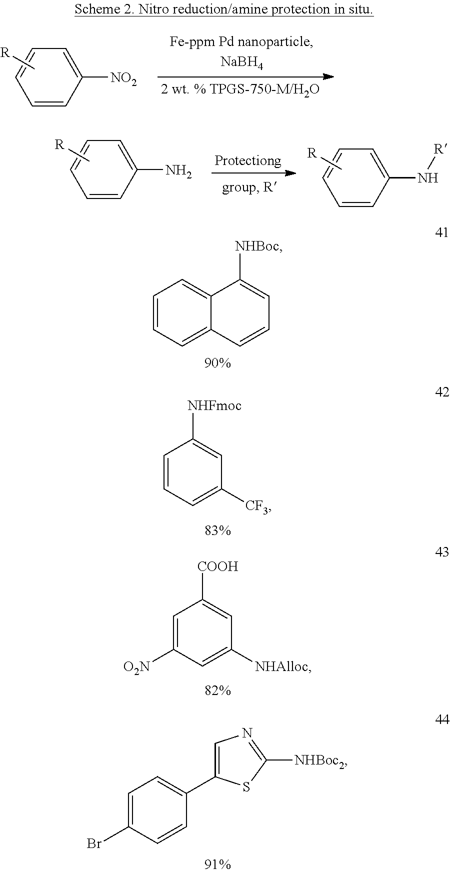

The nitro group reduction can also serve as the precursor step to other secondary reactions. For example, benzene-1,2-diamine is produced from 1,2-dinitrobenzene, which can be used in an oxidative cyclization in one pot to benzimidazole 47 in excellent yield. (Scheme 3).

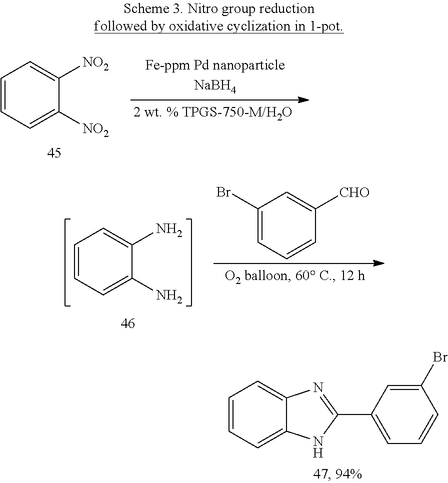

The aqueous reaction mixture may be recycled and re-used. Once the reduction is complete, in-flask extraction with minimum amounts of a single organic solvent allows the isolation and purification of the desired product. Adjustment of the pH, such as to pH 7, using an acid, such as conc. HCl, along with addition of fresh NaBH₄, leads to an active catalyst that is ready for re-introduction of a nitroarene. E Factors may be used as a metric to evaluate the environmental impact of a given reaction. See Sheldon, R. A. Green Chem. 2007, 9, 1261. As shown in Scheme 5, an E Factor for Step A based on utilization of organic solvent (e.g., EtOAc) has been calculated to be 4.8, or 11.4 if water is included, both E values being quite low relative to those characteristic of the fine chemicals and pharmaceutical processes. Lipshutz, B. H. et al. Angew. Chem., Int. Ed. 2013, 52, 10952. The E Factors of 5.5 and 11.3 are associated with a newly developed amidation step. Gabriel, C. M., F.; Lipshutz, B. H. et al. Org. Lett., 2015, 17, 3968. When these reactions are run in tandem, the overall E Factors are only 5.0 or 8.3 for the two steps.

A 3-step sequence, shown in Scheme 5, Equation B, using 1-bromo-4-nitrobenzene as starting material, produces the complex biaryl 56 in good overall isolated yield with relatively low E Factors of 6.2 and 12.8.

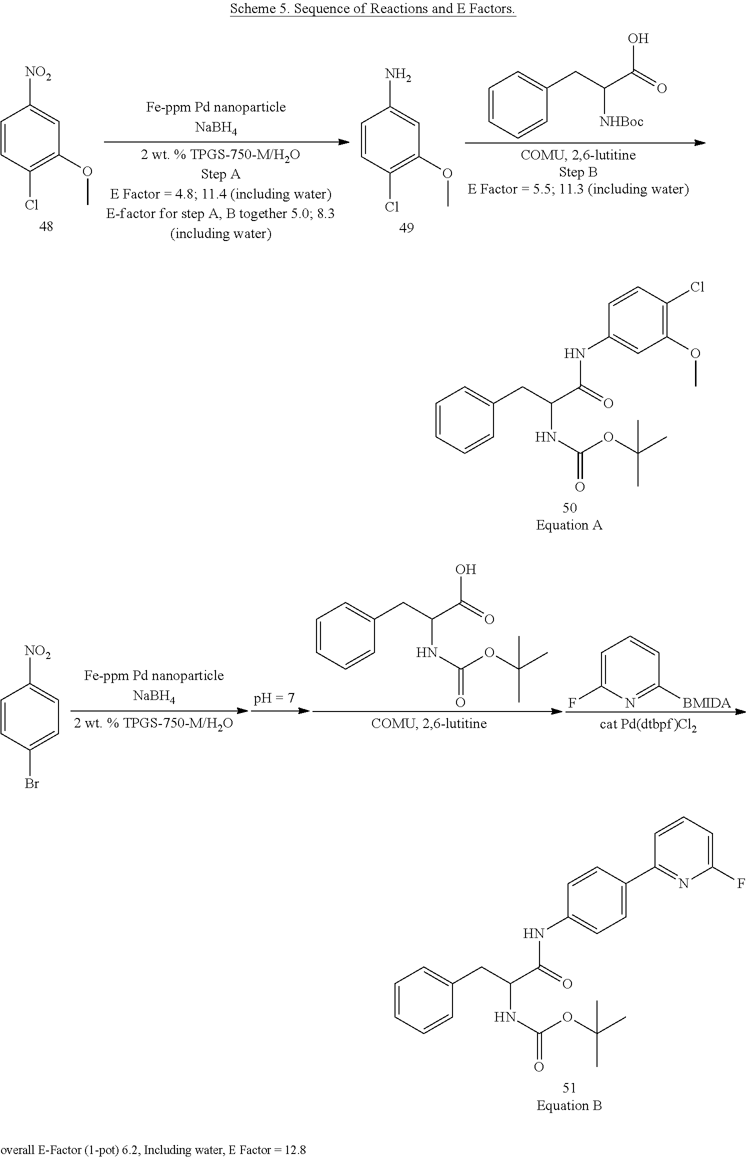

The nitro group reduction may follow classical sequential nitro reduction to the aniline compound, via intermediate nitroso and hydroxylamine compounds. In a control experiment and H/D transfer experiment, the hydrogen source which forms the reduced amine, RNH₂, mainly derives from NaBH₄. Thus, the palladium hydride that is presumably formed may be the active reducing agent. However, the details of interaction between Pd and Fe remain unclear. In fact, a reaction conducted without Fe, and only 80 ppm Pd led to no conversion under otherwise identical conditions.

The present method leads to excellent chemoselectivity when used in the presence of various functional groups (as in Table 2). Without being bound by any theory proposed herein, it is believed that Fe, on the one hand, may work as a Lewis acid, which activates the nitro group; and on the other hand, the Fe supports and disperses, as a platform, ppm levels of Pd which in the composite form highly efficient nanoscale particles. A proposed schematic of the mechanism for this process is outlined in Scheme 6.

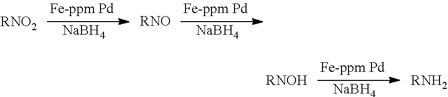

Similarly, Fe-ppm Ni nanoparticles (Fe-ppm Ni NPs) can also reduce nitro groups on aromatics and heteroaromatics. In one aspect, the reduction is complete in one hour or less under micellar conditions run at a global concentration of 0.5 M.

In another embodiment, the above described processes may use Ni, instead of Pd, to form the Fe-ppm Ni nanoparticles that is also effective for reducing nitro compounds to the corresponding amine compounds. Amounts of Ni salts (e.g., NiCl₂, Ni(acac)₂, etc.) are typically in the 150-400 ppm range, although this may vary without significant change in the activity of the resulting NPs.

Accordingly, there is provided Fe-ppm Pd (Fe—Pd NPs), Fe-ppm Ni (Fe—Ni NPs) and Fe-ppm Pd+Ni NPs (Fe—Pd—Ni NPs) nanoparticles that catalyze reductions of aliphatic, aromatic and heteroaromatic nitro compounds. In one aspect, the reaction proceeds in good-to-excellent yields, such as 70% yield, 80% yield, 90% yield, 95% yield or greater than 97% yield, and in high chemoselectivity for a variety of compounds and functional groups. In another aspect, the combination of Fe—Pd NPs, Fe—Ni NPs or Fe-ppm Pd+Ni NPs, and a surfactant unique to micellar catalysis accounts for the exceptionally mild reaction profile. In addition, the process not only exhibits considerable breadth in terms of multi-component reactions run in aqueous media, but offers catalyst recyclability as well as an environmentally responsible technology.

The foregoing examples of the related art and limitations are intended to be illustrative and not exclusive. Other limitations of the related art will become apparent to those of skill in the art upon a reading of the specification and a study of the drawings or figures as provided herein.

### SUMMARY OF THE INVENTION

As a result of a unique synergy between iron-ppm Pd nanoparticles or iron-ppm Ni nanoparticles, and PEG-containing designer surfactants, a facile reduction of nitro-aromatics and nitro-heteroaromatics can be effected in water, and in some processes, at room temperature. This technology involves low catalyst loadings, is highly chemoselective, and tolerates a large variety of functional groups. The process, which includes recycling of the entire aqueous medium, offers a general, versatile, and environmentally responsible approach to highly valued reductions of nitro group-containing compounds. The present method provides an effective and environmentally useful reagents and processes for the reduction of nitro compounds that may be conducted in water and provide low E factors.

The following embodiments, aspects, and variations thereof are exemplary and illustrative are not intended to be limiting in scope.

In one embodiment, the present application discloses a method of reducing inexpensive FeCl₃ with MeMgCl in THF at room temperature, and in the presence of ppm levels of various transition metal salts, new nanoparticles (NPs) are formed that can be used to carry out transition metal-catalyzed reactions in water under mild reaction conditions. The various metals salts used to “dope” these iron NPs include platinoids (e.g., Pd(OAc)₂), and base metals, such as salts of Ni and Cu. In one aspect, these novel NPs serve as catalysts for Pd-catalyzed cross-couplings when formed in the presence of phosphine ligands, and for nitro group reductions when formed in the absence of a ligand. They also mediate related reactions using nickel, and several other types of reactions when copper is present (e.g., click chemistry). This invention thus represents a fundamentally new skeleton derived from a single precursor iron salt (i.e., FeCl₃) that serves as a platform on which several metals, at the ppm level, can be implanted leading to high catalyst reactivity under environmentally responsible conditions, and at the ppm level of transition metal.

In one embodiment, there is provided a nanoparticle complex comprising: a) one or more transition metal salts, or a combination of the transition metal salts; b) an iron salt; and c) a residual element of a reducing agent; wherein the nanoparticle complex is obtained by: i) a reaction of the reducing agent with the one or more transition metal salts; ii) a reaction of the reducing agent with the one or more transition metal salts and the iron salt; iii) a reaction of the reducing agent with a combination of the transition metal salts; or iv) a reaction of the reducing agent with a combination of the transition metal salts and the iron salt. In another embodiment, there is provided a nanoparticle complex comprising: a) one or more transition metal salts, or a combination of the transition metal salts; b) an iron salt; and c) a residual element of a reducing agent used to make the complex.

In another embodiment, there is provided a nanoparticle complex comprising: a) one or more transition metal salts, or a combination of the transition metal salts; b) an iron salt; and c) a residual element of a reducing agent used to make the complex. In another embodiment, there is provided a nanoparticle complex prepared by a process comprising of: a) providing one or more transition metal salts or a combination of the transition metal salts; b) contacting the one or more transition metal salts or a combination of the transition metal salts with an iron salt to form a mixture of salts; and c) contacting the mixture of salts with a reducing agent under conditions sufficient to form the reduced nanoparticle complex. In another embodiment, there is provided a process for the preparation of a reduced nanoparticle complex, the process comprising: a) providing one or more transition metal salts or a combination of the transition metal salts; b) contacting the one or more transition metal salts or a combination of the transition metal salts with an iron salt to form a mixture of salts; and c) contacting the mixture of salts with a reducing agent under conditions sufficient to form the reduced nanoparticle complex. In one variation, there is provided a nanoparticle complex prepared by the above process.

In another embodiment, there is provided a process for the preparation of a reduced nanoparticle complex, the process comprising: a) providing one or more transition metal salts or a combination of the transition metal salts; b) contacting the one or more transition metal salts or a combination of the transition metal salts with an iron salt to form a mixture of salts; and c) contacting the mixture of salts with a reducing agent under conditions sufficient to form the reduced nanoparticle complex. In one variation, there is provided a nanoparticle complex prepared by the above process. In one variation, the terms as referred to and as used in the present application, the term composition is the same as, or synonymous with, a nanoparticle complex.

In one embodiment, there is provided a composition for the reduction of an organic compound comprising a nitro group to form an organic compound comprising an amine group, the composition comprising: a) one or more transition metal salts or a combination of the transition metal salts; b) an iron salt; c) a reducing agent; and d) a first organic solvent. In one variation, the transition metal include all transition metals, and may include nickel, cobalt, iron, manganese, chromium, vanadium, titanium and scandium. In one variation, the combination of the transition salts may include two (2) transition metals, three (3) transition metals, four (4) transition metals, or more. In another variation, for example, the combination may include a mixture of Fe with Pd and Ni, Ni with Pd, a mixture of Ni with Co, Ni with Fe, Ni with Mn, Ni with Ti, Co with Fe, Co with Mn, Fe with Mn, Fe with Ti; Ni with Co and Fe, Ni with Co and Mn, Ni with Mn and Ti and Fe, Fe with Co and Ti, etc . . .

In another embodiment, the composition may be used for the reduction of compounds with an alkyne group, an alkene group or a nitro group, or a compound having a mixture of alkyne, alkene and nitro groups. In one variation, depending on the reductive composition, the reduction of the alkyne may form an alkene, as a single E or Z alkene isomer or a mixture of E and Z alkene isomers; or the reduction may form an alkane. In another variation, the composition may be used to reduce a compound comprising both an alkyne group (and/or an alkene group) and a nitro group, wherein the composition is chemo-selective to reduce only the nitro group in the presence of the alkyne or alkene group. In one variation, the composition may be used to reduce an aldehyde to an alcohol. In another variation, the composition may be used to chemo-selectively reduce the nitro group into an amine in a compound comprising both an aldehyde group and a nitro group.

In another variation, the composition may be used to reduce aryl halides, such as aryl iodides, aryl bromides, aryl chlorides and aryl sulfonates (e.g., triflates, nonaflates, tosylates and mesylates) to the corresponding aryl group.

In another embodiment, the composition further comprises a reaction medium selected from the group consisting of one or more surfactants and water, optionally further comprising a second organic solvent as a co-solvent. In another embodiment of the composition, the organic compound is selected from the group consisting of an aliphatic, aromatic, heteroaromatic or heterocyclic compound. In one variation, the aliphatic, aromatic, heteroaromatic compound is optionally functionalized with one or more functional groups selected from the group consisting of —CF₃, halogen (F, Cl, Br and I), —CN, —OH, —NH₂, —NRR′, —CHO, —COR′, —C≡C, —C≡C—, —CO₂R, aryl, heteroaryl and heterocyclyl, wherein R and R′ are each independently selected from the group consisting of H and C₁₋₆alkyl, aryl etc . . .

In one embodiment of the above composition, the transition metal salt is a nickel salt, copper salt or a palladium salt, or a combination of the transition metal salt thereof. In one variation, the nickel salt is a nickel(II) salt. In another embodiment of the composition, the nickel salt is selected from the group consisting of NiCl₂, NiCl₂.6H₂O, NiCl₂.xH₂O, Ni(acac)₂, NiBr₂, NiBr₂.3H₂O, NiBr₂.xH₂O, Ni(acac)₂.4H₂O and Ni(OCOCH₃)₂.4H₂O; or any other Ni(II) species. In one variation of the above composition, the nickel salt is present at 150-400 ppm relative to iron. In another variation, the nickel salt is present at 100 ppm, 150 ppm, 200 ppm, 250 ppm, 300 ppm, 350 ppm, 400 ppm, 450 ppm or 500 ppm; 1,000 ppm, 3,000 ppm, 5,000 ppm or less than about 10,000 ppm. In another variation, the nickel salt is present at 0.2 to 1% relative to iron.

In another aspect of the composition, the copper salt is selected from the group consisting of CuBr, CuCl, Cu(NO₃)₂, CuI, CuSO₄, CuOAc, CuSO₄ 5 H₂O, Cu/C, Cu(OAc)₂, CuOTf.C₆H₆ (OTf is trifluoromethanesulfonate) and [Cu(NCCH₃)₄] [PF₆]. In one variation, the copper salt is a copper (I) or a copper (II) salt. In another variation, the reaction is conducted in the presence of a base, such as Et₃N, 2,6-lutidine or DIPEA.

In another embodiment, the palladium salt is selected from the group consisting of Pd(OAc)₂, PdCl₂, PdI₂, PdBr₂, Pd(CN)₂, Pd(NO₃)₂ and PdSO₄; or any other Pd(0-IV) species, such as Pd(II) species. In one variation of the composition, the palladium salt is present at less than about 5,000 ppm, 4,000 ppm, 3,000 ppm, 2,000ppm, 1,000 ppm, 500 ppm, 300 ppm, 200 ppm, 100 ppm, 90 ppm, 80 ppm, 70 ppm, 60 ppm, 50 ppm, 40 ppm, 30 ppm, 20 ppm or less. In one variation of the composition, the palladium salt is present as an impurity in the iron salt at the 1-400 ppm level, at about 10 ppm, 50 ppm, 80 ppm, 100 ppm, 150 ppm, 200 ppm, 250 ppm, 300 ppm, 350 ppm and 400 ppm. In another variation, the palladium salt is added to the iron salt in less than about 1,000 ppm. In another variation of the composition, the iron salt has a purity of less than 99.999%, 98% or 97%.

In another embodiment, the iron salt has a purity of less than 99.999% and the iron salt is doped with a palladium salt or a nickel salt, at 5,000 ppm, 3,000 ppm, 1,000 ppm, 500 ppm, 300 ppm, 200 ppm, 100 ppm, 90 ppm or 80 ppm or less. In another embodiment, the source of iron is selected from the group consisting of FeCl₃ or any salt, in particular iron salts, such as Fe(II) or Fe(III) salts.

In another embodiment of the composition, the surfactant is selected from the group consisting of TPGS-350-M, TPGS-550-M, TPGS-750-M, TPGS-1,000-M, TPGS-2000-M, Triton X-100, TPGS (polyoxyethanyl-a-tocopheryl succinate), TPGS-400-100 (D-alpha-tocopheryl polyethylene glycol 400-1000 succinate), such as TPGS-1000 (D-alpha-tocopheryl polyethylene glycol 1000 succinate), wherein the tocopheryl is the natural tocopherol isomer or the un-natural tocopherol isomer; Nok, Pluronic, Poloxamer 188, Polysorbate 80, Polysorbate 20, Vit E-TPGS, Solutol HS 15, PEG-40 Hydrogenated castor oil (Cremophor RH40), PEG-35 Castor oil (Cremophor EL), Triton X-100, all Brij surfactants, ionic surfactants (e.g., SDS), PEG-8-glyceryl capylate/caprate (Labrasol), PEG-32-glyceryl laurate (Gelucire 44/14), PEG-32-glyceryl palmitostearate (Gelucire 50/13); Polysorbate 85, Polyglyceryl-6-dioleate (Caprol MPGO), Mixtures of high and low HLB emulsifiers; Sorbitan monooleate (Span 80), Capmul MCM, Maisine 35-1, Glyceryl monooleate, Glyceryl monolinoleate, PEG-6-glyceryl oleate (Labrafil M 1944 CS), PEG-6-glyceryl linoleate (Labrafil M 2125 CS), Oleic acid, Linoleic acid, Propylene glycol monocaprylate (e.g. Capmul PG-8 or Capryol 90), Propylene glycol monolaurate (e.g., Capmul PG-12 or Lauroglycol 90), Polyglyceryl-3 dioleate (Plurol Oleique CC497), and Polyglyceryl-3 diisostearate (Plurol Diisostearique), or combinations thereof. In one variation, the surfactant is TPGS-750-M or Triton X-100. In another variation, the surfactant is TPGS-750-M that is present at 2 wt %. In another variation, TPGS-750-M is present at 1 wt %, 2 wt %, 3 wt %, 4 wt %, 5 wt % or 10 wt %.

In another embodiment, the reducing agent is selected from the group consisting of a Grignard reagent or a hydride reagent. In one variation of the composition, the hydride reagent is a metal hydride. In another embodiment, the Grignard reagent is selected from the group consisting of MeMgCl, EtMgCl, PrMgCl, i-PrMgCl, BuMgCl, vinylMgCl, PhMgCl, MeMgBr, EtMgBr, PrMgBr, BuMgBr, vinylMgBr and PhMgBr, or a mixture of 2 or more Grignard reagents. In one embodiment, the reducing agent is selected from the group consisting of NaBH₄, LiBH₄, KBH₄, LiAlH₄, LiAlH(OEt)₃, LiAlH(OMe)₃, LiAlH(O-tBut)₃, sodium bis(2-methoxyethoxy)aluminum hydride (Red-Al), LiBHEt₃, NaBH₃CN, BH₃ and diisobutylaluminum hydride (DIBAL-H or iBu₂AlH), or any silanes such as Et₃SiH, PMHS etc . . . , or dihydrogen formate or ammonium formate. In one variation, the reducing agent is NaBH₄, LiBH₄ or KBH₄. In another variation, the reducing agent, such as KBH₄ or LiBH₄, is present at 1, 2 or 3 equivalents relative to the iron salt. In one variation, the reducing agent is selected from KBH₄ or NaBH₄—KCl, a mixture of NaBH₄ and a potassium salt (KX, where X is a halide). In one variation, the KX is selected from the group consisting of KCl, KBr and KI. In a particular variation, the reducing agent comprises of NaBH₄ and KX, where the ratio of NaBH₄:KX is about 1:1; 1.5:1; 2:1; 1:1.5; 1:2; 1:3; 1:4; 1:5; or about 1:10. In another variation, the NaBH₄ is present at about 1.0 to 1.5 equivalents relative to the iron salt.

In another embodiment of the composition, the solvent or co-solvent is selected from the group consisting of acetonitrile, THF, DMF, toluene, xylenes, 2-methyl-THF, diethyl ether, 1,4-dioxane, glyme, PEG, MPEG, MTBE, MeOH, EtOH, PrOH, i-PrOH, nBuOH, sBuOH, i-PrOAc and ethyl acetate, or mixtures thereof, wherein the solvent or co-solvent is present in 1-10% vol/vol, or from about 0.01-50% vol/vol, 5-85% vol/vol or about 10-75% vol/vol relative to water. In one variation of the composition, the solvent or co-solvent is THF.

In one embodiment, there is provided a composition for the reduction of an organic compound comprising a nitro group to form an organic compound comprising an amine group, wherein the composition is prepared from contacting a reducing agent with a) one or more transition metal salts or a mixture of transition metal salts; b) an iron salt, in a first organic solvent; followed by addition of c) a surfactant; and d) water. In one variation, the first solvent or the second solvent is independently selected from the group consisting of acetonitrile, THF, DMF, toluene, xylenes, methyl-THF, diethyl ether, MTBE, PEG, MPEG, MeOH, EtOH, PrOH, i-PrOH, nBuOH, sBuOH, i-PrOAc and ethyl acetate; or mixtures thereof. In another embodiment, the composition containing the iron salt is a nanoparticulate composition. In one variation, the size of the nanoparticulate or nanoparticles ranges from about 10 nm to 200 nm or more, about 10 nm to 50 nm, or about 50 nm to 200 nm.

In one embodiment, there is provided a method for the reduction of an organic compound comprising a nitro group to form an organic compound comprising an amine group, the method comprising: a) preparing a composition comprising a transition metal salt or a mixture of transition metal salts, and an iron salt; b) contacting the composition in a first organic solvent and with a reducing agent to form a nanoparticulate composition; c) contacting the resulting nanoparticulate composition, to which water containing a surfactant has been added, with an organic compound comprising a nitro group with the nanoparticulate composition for a sufficient period of time to form the organic compound comprising an amine.

In another embodiment, there is provided a method for the copper-catalyzed reaction of an azide with an alkyne to form a 5-membered heteroatom ring, the method comprising: a) preparing a composition comprising a transition metal salt or a mixture of transition metal salts, and an iron salt; b) contacting the composition in a first organic solvent and with a reducing agent to form a nanoparticulate composition; c) contacting the resulting nanoparticulate composition, to which water containing a surfactant has been added, with the azide and the alkyne, with the nanoparticulate composition for a sufficient period of time to form the 5-membered heteroatom ring. In one aspect, the transition metal salt is a nickel salt, copper salt or a palladium salt, or a combination of transition metal salts. In another aspect, the copper salt is selected from the group consisting of CuBr, CuCl, Cu(NO₃)₂, CuI, CuSO₄, CuOAc, CuSO₄ 5 H₂O, Cu/C, Cu(OAc)₂, CuOTf.C₆H₆ (OTf is trifluoromethanesulfonate) and [Cu(NCCH₃)₄][PF₆].

In another embodiment, the transition metal salt is a nickel salt or a palladium salt, or a mixture of transition metal salts thereof. In another embodiment of the method, the iron salt is selected from the group consisting of FeCl₃ or any other iron salt, such as Fe(II) or Fe(III) salt. In another embodiment, the surfactant is selected from the group consisting of TPGS-750-M, Triton X-100, TPGS (polyoxyethanyl-a-tocopheryl succinate), TPGS-400-1000 (D-alpha-tocopheryl polyethylene glycol 400-1000 succinate), wherein the tocopheryl is the natural tocopherol isomer or the un-natural tocopherol isomer; Nok, Pluronic, Poloxamer 188, Polysorbate 80, Polysorbate 20, Vit E-TPGS, Solutol HS 15, PEG-40 Hydrogenated castor oil (Cremophor RH40), PEG-35 Castor oil (Cremophor EL), Triton X-100, all Brij surfactants, ionic surfactants (e.g., SDS), PEG-8-glyceryl capylate/caprate (Labrasol), PEG-32-glyceryl laurate (Gelucire 44/14), PEG-32-glyceryl palmitostearate (Gelucire 50/13); Polysorbate 85, Polyglyceryl-6-dioleate (Caprol MPGO), Mixtures of high and low HLB emulsifiers; Sorbitan monooleate (Span 80), Capmul MCM, Maisine 35-1, Glyceryl monooleate, Glyceryl monolinoleate, PEG-6-glyceryl oleate (Labrafil M 1944 CS), PEG-6-glyceryl linoleate (Labrafil M 2125 CS), Oleic acid, Linoleic acid, Propylene glycol monocaprylate (e.g. Capmul PG-8 or Capryol 90), Propylene glycol monolaurate (e.g., Capmul PG-12 or Lauroglycol 90), Polyglyceryl-3 dioleate (Plurol Oleique CC497), and Polyglyceryl-3 diisostearate (Plurol Diisostearique), or combinations or mixtures thereof. In another embodiment, the method further comprises a reducing agent. In another embodiment, the reducing agent is selected from the group consisting of a Grignard reagent or a hydride reagent. In one variation of the method, the hydride reagent is a metal hydride. In another embodiment, the Grignard reagent is selected from the group consisting of MeMgCl, EtMgCl, PrMgCl, BuMgCl, vinylMgCl, PhMgCl, MeMgBr, EtMgBr, PrMgBr, BuMgBr, vinylMgBr and PhMgBr, or a mixture of 2 or more Grignard reagents. In another embodiment, the hydride reagent is a selected from the group consisting of NaB H₄, LiBH₄, KBH₄, LiAlH₄, LiAlH(OEt)₃, LiAlH(OMe)₃, LiAlH(O-tBut)₃, sodium bis(2-methoxyethoxy)aluminum hydride (Red-Al), LiBHEt₃, NaBH₃CN, BH₃ and diisobutyl aluminum hydride (DIBAL-H or iBu₂AlH), or any silane, or dihydrogen formate or ammonium formate. In another variation of the above method, the hydride reagent further comprises a metal halide. In another variation, the metal halide is selected from the group consisting of LiCl, NaCl, KCl, LiBr, NaBr, KBr, LiI, NaI and KI. In another variation, the metal halide is KCl.

In one embodiment, the method further comprises a second solvent or co-solvent selected from the group consisting of acetonitrile, THF, DMF, toluene, xylenes, methyl-THF, diethyl ether, 1,4-dioxane, MTBE, PEG, MPEG, MeOH, EtOH, PrOH, i-PrOH, nBuOH, sBuOH, i-PrOAc and ethyl acetate; or mixtures thereof. In one aspect of the above method, the co-solvent is present in 1-10% relative to water. In one variation of the above method, the amine compound is obtained in 70% yield, 80% yield, 90% yield, 95% yield or greater than 97% yield. In another embodiment of the method, an aqueous mixture that may contain one or more organic solvent as co-solvents, is involved in the method and the aqueous mixture is recovered, recycled and re-used. In another variation, an excess of solvent or co-solvent, such as 10 times (×) vol/vol of the reaction mixture, may be added to the reaction mixture to facilitate mixing, processing and/or isolating of the reaction mixture when the reaction is performed at a larger scale, such as for commercial scale processing or manufacture. In one variation, the excess solvent or co-solvent is used in the reaction mixture at 2×, 3×, 4×, 5×, 10×, 15×, 20× or 30× or more vol/vol of the reaction mixture. In another embodiment, the method provides a recycling of the aqueous reaction mixture that comprises an extraction using an organic solvent to remove the amine product, adjustment of the pH using an acid and the addition of fresh reducing agent to provide an active catalyst for reuse or recycle. In one variation of the method, the reducing agent is NaBH₄. In another variation, the pH is adjusted to pH 7. In another variation, the pH is adjusted using conc. HCl. In another variation, the reduction is carried out at room temperature.

In another variation of the above, the organic compound comprising a nitro group is of the Formula I, and the organic compound comprising an amine group is of the Formula II:

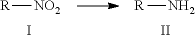

wherein R is selected from the group consisting of an aliphatic, aromatic, heteroaromatic, or a heterocyclic compound. In another embodiment of the above method, the residual palladium content in the amine product is less than 10 ppm.

In addition to the exemplary embodiments, aspects and variations described above, further embodiments, aspects and variations will become apparent by reference to the drawings and figures and by examination of the following descriptions.

### BRIEF DESCRIPTION OF THE FIGURES

FIG. 1 are representative TEM and IR Spectra of Fe-ppm Pd nanoparticles vs. pure THF.

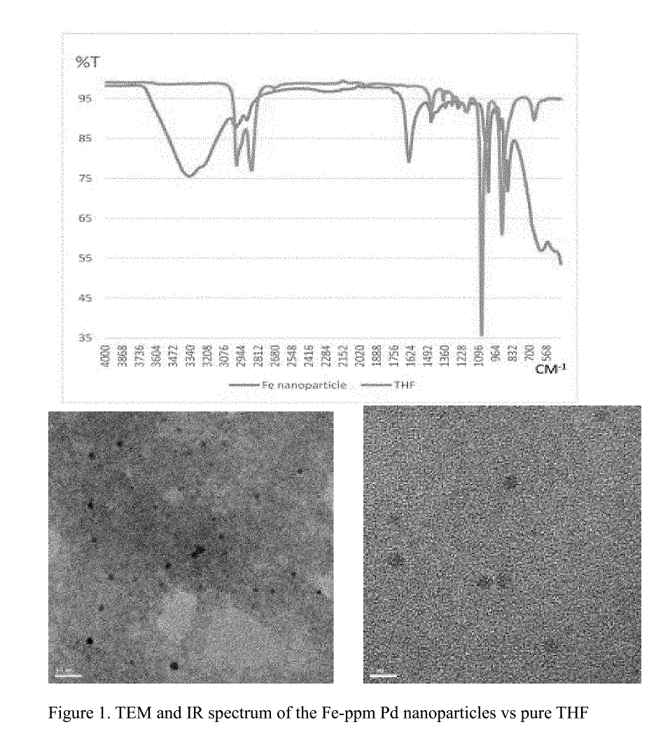

FIG. 2 shows the influence of the surfactant on the reaction profile.

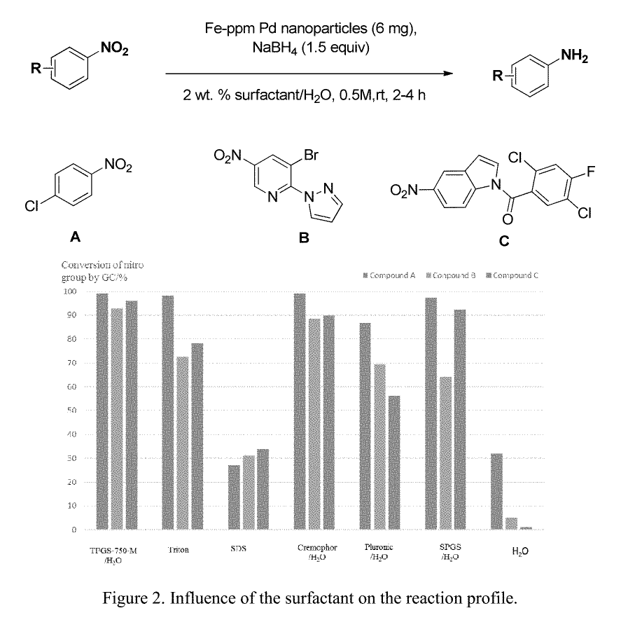

FIG. 3 is a representative spectra showing the 2c IR Spectra of Fe nanoparticle in THF.

FIG. 4 is a representative figure showing the binding energy of Fe appears at 712 eV shows that Fe may exists in Fe(III) valent. XPS did not show the Pd peak due to its low content.

FIG. 5: 2d EDX spectrum for Fe-ppm Pd Nanoparticles and Elemental Analysis.

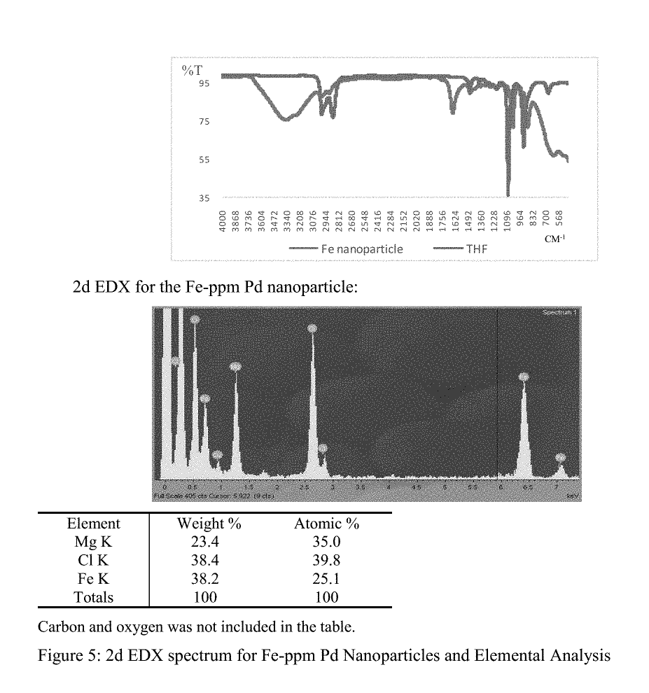

### DETAILED DESCRIPTION OF THE INVENTION

### Definitions

Unless specifically noted otherwise herein, the definitions of the terms used are standard definitions used in the art of organic synthesis and pharmaceutical sciences. Exemplary embodiments, aspects and variations are illustratived in the figures and drawings, and it is intended that the embodiments, aspects and variations, and the figures and drawings disclosed herein are to be considered illustrative and not limiting.

An “alkyl” group is a straight, branched, saturated or unsaturated, aliphatic group having a chain of carbon atoms, optionally with oxygen, nitrogen or sulfur atoms inserted between the carbon atoms in the chain or as indicated. A (C₁₋C₂₀)alkyl, for example, includes alkyl groups that have a chain of between 1 and 20 carbon atoms, and include, for example, the groups methyl, ethyl, propyl, isopropyl, vinyl, allyl, 1-propenyl, isopropenyl, ethynyl, 1-propynyl, 2-propynyl, 1,3-butadienyl, penta-1,3-dienyl, penta-1,4-dienyl, hexa-1,3-dienyl, hexa-1,3,5-trienyl, and the like.

An alkyl as noted with another group such as an aryl group, represented as “arylalkyl” for example, is intended to be a straight, branched, saturated or unsaturated aliphatic divalent group with the number of atoms indicated in the alkyl group (as in (C₁₋C₂₀)alkyl, for example) and/or aryl group (as in (C₅₋C₁₄)aryl, for example) or when no atoms are indicated means a bond between the aryl and the alkyl group. Nonexclusive examples of such group include benzyl, phenethyl and the like.

An “alkylene” group is a straight, branched, saturated or unsaturated aliphatic divalent group with the number of atoms indicated in the alkyl group; for example, a —(C₁₋C₃)alkylene- or —(C₁₋C₃)alkylenyl-.

A “cyclyl” such as a monocyclyl or polycyclyl group includes monocyclic, or linearly fused, angularly fused or bridged polycycloalkyl, or combinations thereof. Such cyclyl group is intended to include the heterocyclyl analogs. A cyclyl group may be saturated, partically saturated or aromatic.

“Halogen” or “halo” means fluorine, chlorine, bromine or iodine.

A “heterocyclyl” or “heterocycle” is a cycloalkyl wherein one or more of the atoms forming the ring is a heteroatom that is a N, O, or S. Non-exclusive examples of heterocyclyl include piperidyl, 4-morpholyl, 4-piperazinyl, pyrrolidinyl, 1,4-diazaperhydroepinyl, 1,3-dioxanyl, and the like.

A “nanoparticulate composition” or “nanoparticle(s)” or “nanoparticle complex” as used interchangeably herein, is a composition containing nanoparticulate particles of metal(s), where the particles are between about 1 and 100 nanometers in size. The composition of the present application may contain some ultrafine particles of about 1 and 100 nanometers in size, some fine particles of about 100 and 2,500 nanometers in size, and coarse particles of about 2,500 and 10,000 nanometers in size, or a mixture of ultrafine, fine and coarse particles.

“Substituted or unsubstituted” or “optionally substituted” means that a group such as, for example, alkyl, aryl, heterocyclyl, (C₁-C₈)cycloalkyl, hetrocyclyl(C₁-C₈)alkyl, aryl(C₁-C₈)alkyl, heteroaryl, heteroaryl(C₁-C₈)alkyl, and the like, unless specifically noted otherwise, may be unsubstituted or, may substituted by 1, 2 or 3 substitutents selected from the group such as halo, nitro, trifluoromethyl, trifluoromethoxy, methoxy, carboxy, —NH₂, —OH, —SH, —NHCH₃, —N(CH₃)₂, —SMe, cyano and the like.

### Experimental:

All reactions were carried out in a sample vial (4 mL) equipped with a Teflon-coated magnetic stir bar. De-ionized water was used directly from the laboratory water system. NaBH₄ was purchased from Alfa Aesar (Cat. No. 13432) and well fined. FeCl₃ was purchased from Acros Organics, Sigma-Aldrich, Alfa Aesar, Chem Impex, respectively. A solution of 2 wt % TPGS-750-M/H₂O was prepared by dissolving TPGS-750-M in degassed HPLC grade water, and was stored under argon. TPGS-750-M was made as previously described¹ and is available from Sigma-Aldrich (Cat. No. 733857). All commercially available reagents were used without further purification. Column chromatography was carried out using silica gel 60 (230-400 mesh, Merck). TLC analysis was done using silica gel TLC with 60 F254 indicators, glass backed. GC-MS data were recorded on an Agilent Technologies 7890A GC system coupled with Agilent Technologies 5975C mass spectrometer using HP-5MS column (30 m×0.250 mm, 0.250 purchased from Agilent Technologies. ¹H and ¹³C NMR spectra were obtained in CDCl₃ or DMSO using 400 MHz, 500 MHz or 600 MHz Varian NMR spectrometer. Chemical shifts in ¹H NMR spectra are reported in parts per million (ppm) on the δ scale (internal standard of CDCl₃ (7.27 ppm) or the central peak of DMSO-d₆ (2.50 ppm)). Data are as follows: chemical shift, multiplicity (s=singlet, d=doublet, t=triplet, q=quartet, quin=quintet), integration, and coupling constant in Hertz (Hz). Chemical shifts in ¹³C NMR spectra are in ppm on the δ scale from the central peak of residual CDCl₃ (77.00 ppm) or the central peak of DMSO-d₆ (39.51 ppm).

### Preparation and Characterisation of Fe-ppm Pd Nanoparticles:

### Preparation of Fe-ppm Pd Nanoparticles.

In an oven dried 2-neck round-bottomed flask (2N-RBF), anhydrous 99.99% pure FeCl₃ (488 mg, 3 mmol), Pd(OAc)₂ (2.2 mg, 0.01 mmol) was added under an atmosphere of dry argon. The flask was covered with a septum, and 15 mL dry THF was added, and the mixture was stirred for 20 min at rt. Under a dry atmosphere at rt, a 0.5 M solution of MeMgCl in THF was slowly (1 drop/2 sec) added to the reaction mixture until no gas was released (about 6 mL, 3 mmol). After addition of Grignard reagent, the mixture was stirred for 20 min at rt. An yellow-brown color showed generation of nanomaterial.

After 20 min, the mixture was quenched with pentane (containing trace of water). THF was then evaporated under reduced pressure at rt. Removal of THF was followed by triturating the mixture with pentane to provide yellow-brown colored nanomaterial as a powder (trituration was repeated 3-4 times). The Fe nanoparticles obtained were dried under reduced pressure at rt for 10 min yielding 1.5 g Fe-ppm Pd nanoparticles. The material was used as such for subsequent reactions under micelles conditions. (Caution! The iron nanoparticles should be stored under argon in a refrigerator, otherwise the color changes and the reactivity drops overtime).

### TEM Images of the Fe Nanoparticles:

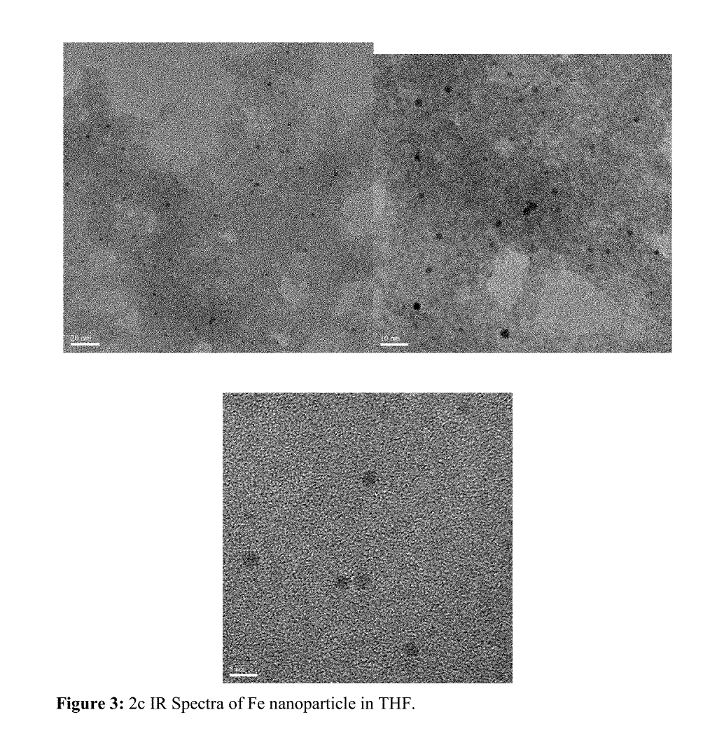

Field Emission Transmission Electron Microscope (TEM) FEI Tecnai™ T-20 was used for the TEM images. From the TEM, it was shown that the Fe-ppm Pd nanoparticle was uniformly dispersed in its supports (that may be Mg salt, oxide or hydroxide bound to THF). FIG. 3 shows the 2c IR Spectra of Fe nanoparticle in THF. From the comparison of IR between Fe-ppm Pd nanoparticles that contain THF, and pure THF, there is an apparent shift in the spectrum presumably due to interactions with metals present in the NPs.

From EDX, it can be shown that on the surface of the particle, the ratio of Mg/Fe is about 1.4/1, while Pd is too low to show in EDX.

### 2e XPS for Fe-ppm Pd Nanoparticles:

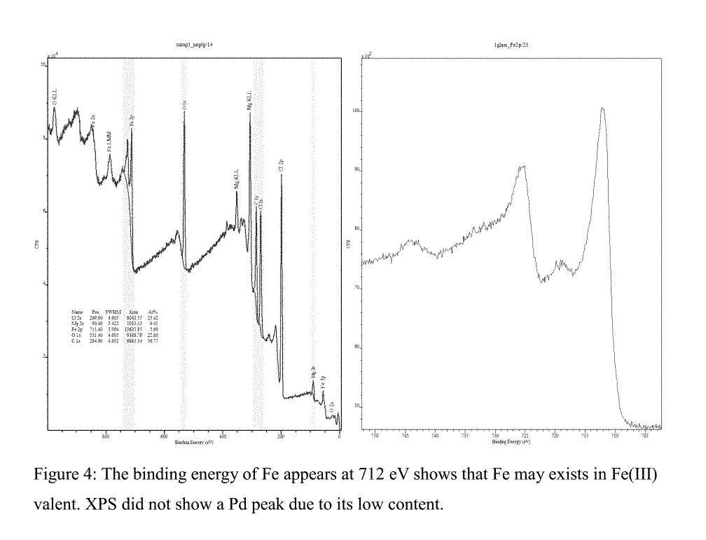

The XPS scans were run on a Kratos Axis Ultra DLD instrument (Kratos Analytical, Manchester, UK). The source used was a monochromated Al k-alpha beam (1486 eV). Survey scans were measured at a pass energy of 160 eV. High-resolution scans of Cl, C, and O were run at 20 eV pass energy, and Fe 2p was run at 40 eV pass energy. The energy scale was calibrated by setting the Cls peak to 285.0 eV. Similar with the EDX result, as shown in FIG. 4, the ratio of Mg and Fe is about 1.6/1 and with a large amount carbon and oxygen which may come from THF. The binding energy of Fe appears at 712 eV shows that Fe may exists in Fe(III) valent. XPS did not show the Pd peak due to its low content.

### 2f ICP for Fe Nanoparticles:

| Samples | ICP-OES¹ % Iron |
|---|---|
| REILLJO3-001-EXP049-001 | 8.59% |

¹Results from Robertson Microlit Laboratories, Cambridge Mass.

ICP test for the Fe content of the Fe-ppm Pd nanoparticles is 8.6%. The Pd was calculated to 80 ppm with 6 mg Fe-ppm Pd nanoparticles in a 0.5 M reaction. Optimization of nitro group reductions

Surfactant selection using 1-chloro-4-nitrobenzene as a model substrate^{a}

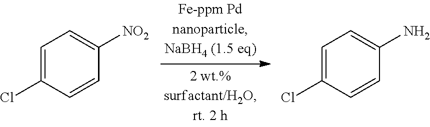 [SMILES: O=[N+]([O-])c1ccc(Cl)cc1 ; Nc1ccc(Cl)cc1]

| Entry | Surfactant/Water | Yield(%)^{b} |
|---|---|---|
| 1 | 2 wt % TPGS/H₂O | 99 (95^{c}) |
| 2 | 2 wt % Triton X-100//H₂O | 98 |
| 3 | 2 wt % SDS/H₂O | 27 |
| 4 | 2 wt % cremophor/H₂O | 99 |
| 5 | 2 wt % pluronic/H₂O | 87 |
| 6 | 2 wt % Nok/H₂O | 97 |
| 7^{d} | H₂O | 32 |

^{a}Reaction conditions: 4-chloroaniline (78.5 mg, 0.5 mmol), Fe nanoparticles (6 mg), NaBH₄ (28.5 mg, 0.75 mmol, surfactant/H₂O 1 mL, rt. 2 h.
^{b}GC yield.
^{c}Isolated yield;
^{d}16 h.

Surfactant selection for nitro hydrogenation using 3-bromo-
5-nitro-2-(1H-pyrazol-1-yl)pyridine as a model substrate^{a}

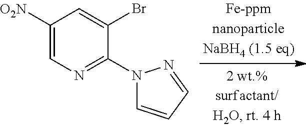 [SMILES: O=[N+]([O-])c1cnc(-n2cccn2)c(Br)c1]

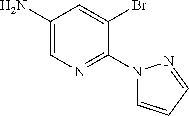 [SMILES: Nc1cnc(-n2cccn2)c(Br)c1]

| entry | surfactant/solvent | yield (%)^{b} |
|---|---|---|
| 1 | 2 wt % TPGS-750-M/H₂O | 93 |
| 2 | 2 wt % SDS/H₂O | 31 |
| 2 | 2 wt % Triton X-100 | 72 |
| 3 | 2 wt % pluronic/H₂O | 69 |
| 4 | 2 wt % cremophor/H₂O | 89 |
| 5 | 2 wt % Nok/H₂O | 64 |
| 6 | H₂O | 5 |

^{a}Reaction conditions: 3-bromo-5-nitro-2-(1H-pyrazol-1-yl)pyridine (134 mg, 0.5 mmol), Fe nanoparticles (6 mg), NaBH₄ (28.5 mg, 0.75 mmol, surfactant/H₂O 1 mL, rt, 4 h. ^{b}GC yields.

Surfactant selection for nitro hydrogenation using
3-bromo-5-nitro-2-(1H-pyrazol-1-yl)pyridine^{a}:

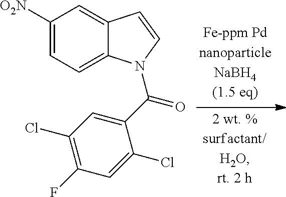 [SMILES: O=C(c1cc(Cl)c(F)cc1Cl)n1ccc2cc([N+](=O)[O-])ccc21]

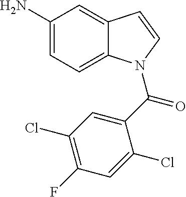 [SMILES: Nc1ccc2c(ccn2C(=O)c2cc(Cl)c(F)cc2Cl)c1]

| Entry | Surfactant/Solvent | Yield (%)^{b} |
|---|---|---|
| 1 | 2 wt % TPGS-750-M/H₂O | 96 |
| 2 | 2 wt % SDS/H₂O | 31 |
| 2 | 2 wt % Triton X-100 | 78 |
| 3 | 2 wt % Pluronic/H₂O | 56 |
| 4 | 2 wt % Cremophor/H₂O | 90 |
| 5 | 2 wt % Nok/H₂O | 92 |
| 6 | H₂O | 1 |

^{a}Reaction conditions: (2,5-dichloro-4-fluorophenyl)(5-nitro-1H-indol-1-yl)methanone (176 mg, 0.5 mmol), Fe nanoparticle (6 mg), NaBH₄ (28.5 mg, 0.75 mmol, surfactant/H₂O (1 mL), rt. 2 h.
^{b}GC yield.

Optimization with different FeCl₃ sources and
optimal amounts of Pd needed.^{a}

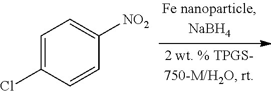

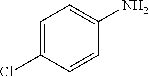

| | | Doped Pd | Time | Yield |
|---|---|---|---|---|
| Entry | FeCl₃ source | amount/ppm | (h) | (%) ^{b} |
| 1 | Sigma-Aldrich 97% FeCl₃ | 0 | 2 | |
| 2 | Alfa-Aesar 98% FeCl₃ | 0 | 2 | 1 |
| 3 | Chem-impex 97% FeCl₃ | 0 | 2 | 90 |
| 4 | Sigma-Aldrich 99.99% FeCl₃ | 0 | 2 | trace |
| 5 | Sigma-Aldrich 99.99% FeCl₃ | 20 | 3 | 60 |
| 6 | Sigma-Aldrich 99.99% FeCl₃ | 40 | 2 | 94 |
| 7 | Sigma-Aldrich 99.99% FeCl₃ | 80 | 2 | 99 |
| 8 | Sigma-Aldrich 99.99% FeCl₃ | 160 | 1 | 99 |
| 9 | Alfa-Aesar 98% FeCl₃ | 40 | 2 | 95 |
| 10 | Alfa-Aesar 98% FeCl₃ | 80 | 2 | 99 |
| 11 | Sigma-Aldrich 97% FeCl₃ | 80 | 2 | |
| 12 | Sigma-Aldrich 99.99% FeCl₃ | 160^{c} | 2 | 90 |
| 13 | Sigma-Aldrich 99.99% FeCl₃ | 320^{d} | 4 | 3 |
| 14 | Sigma-Aldrich 99.99% FeCl₃ | 80 | 2 | 99 |
| 15 | No FeCl₃ | 80 | 4 | 0 |

^{a}Reaction conditions: 4-chloroaniline (78.5 mg, 0.5 mmol), Fe nanoparticles (6 mg), NaBH₄ (28.5 mg, 0.75 mmol, surfactant/H₂O (1 mL), rt. 2 h.
^{b} GC yield.
^{c}doped with Ni(OAc)₂.
^{d}doped with Cu(OAc)₂.
^{e}without the formation of nanoparticles.

As is shown in Tables 3a-3c, a variety of surfactants can be used for these reductions. The specific choice can vary depending upon the substrate, but several are effective, suggesting that others untested could be used in a similar capacity. In Table 3d, the trace amount of impurities may account for the nitro group reduction. Previous work using low price FeCl₃ (usually 97% pure) can smoothly reduce the nitro group while attempts with high quality FeCl₃ only results in poor yield. For these substrates, metals such as Pd, Ni, Cu were doped to highly pure (99.9999%) FeCl₃, and Pd was found to be the most effective metal, with ca. 80 ppm level Pd needed for full conversion.

Optimization with nanoparticle loading^{a}:

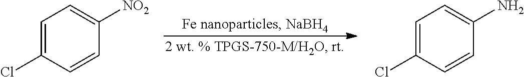 [SMILES: O=[N+]([O-])c1ccc(Cl)cc1 ; Nc1ccc(Cl)cc1]

| | Fe-ppm Pd nanoparticle | Doped Pd | | |
|---|---|---|---|---|
| Entry | amount/mg | amount/ppm | Time (h) | Yield (%) ^{b} |
| 1 | 0 | 0 | 2 | 0 |
| 2 | 3 | 40 | 2 | 65 |
| 3 | 6 | 80 | 2 | 99 |
| 4 | 12 | 160 | 2 | 95 (99^{c}) |
| 5 | 3 | 80 | 2 | 95 |

^{a}Reaction conditions: 4-Chloronitrobenzene (78.5 mg, 0.5 mmol), Fe nanoparticles (6 mg), NaBH₄ (28.5 mg, 0.75 mmol, surfactant/H₂O (1 mL), rt. 2 h.
^{b} GC yield.
^{c}NaBH₄ (1 mmol).

Similar to Table 3d, less amounts of Fe-ppm Pd nanoparticles may lead to decreased yield. With the same level Pd, but decreasing the Fe amount, also slightly dropped the yield. On the other hand, too much reagent may speed up the consumption of NaBH₄.

Optimization with [H] source ^{a}:

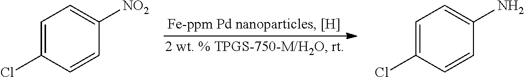 [SMILES: O=[N+]([O-])c1ccc(Cl)cc1 ; Nc1ccc(Cl)cc1]

| Entry | [H] source | Time (h) | yield (%) ^{b} |
|---|---|---|---|
| 1 | NaBH₄ (1.5 equiv) | 2 | 99 |
| 2 | PMHS (1.5 equiv) | 2 | 10 |
| 3 | H₂ balloon | 2 | 3 |
| 4 | N₂H₄•H₂O (3 equiv) | 2 | 0 |
| 4 | HCOOH/Et₃N (2 equiv) | 2 | 0 |

^{a} Reaction conditions: 4-chloronitrobenzene (78.5 mg, 0.5 mmol), Fe nanoparticles (6 mg), NaBH₄ (28.5 mg, 0.75 mmol, surfactant/H₂O (1 mL), rt. 2 h.
^{b} GC yield.
^{c}NaBH₄ (1 mmol).

Optimization with amount of NaBH₄^{a}:

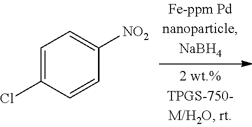

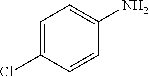

| Entry | NaBH₄ (equiv) | Time (h) | Yield (%) ^{b} |
|---|---|---|---|
| 1 | 0.5 | 2 | 57 |
| 2 | 1 | 2 | 83 |
| 3 | 1.5 | 2 | 99 |
| 4 | 2 | 2 | 99 |
| 4 | 3 | 2 | 99 |

Further optimization of nitro group reductions using nemodipine as a model^{a}:

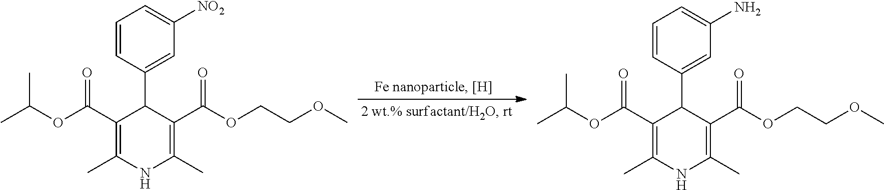 [SMILES: COCCOC(=O)C1=C(C)NC(C)=C(C(=O)OC(C)C)C1c1cccc([N+](=O)[O-])c1 ; COCCOC(=O)C1=C(C)NC(C)=C(C(=O)OC(C)C)C1c1cccc(N)c1]

| | Catalyst | [H] source | | Time | Yield |
|---|---|---|---|---|---|
| Entry | amount/mg | (equiv) | Co-solvent | (h) | (%)^{b} |
| 1 | 6 | NaBH₄ (1.5) | — | 16 | 11 |
| 2 | 12 | NaBH₄ (3.0) | — | 16 | 24 |
| 3 | 12 | NaBH₄ (3.0) | methanol (0.1 mL) | 16 | 77 |
| 4 | 12 | NaBH₄ (3.0) | THF (0.1 mL) | 6 | 90 |
| 5^{c} | 12 | NaBH₄ (3.0) | THF (0.1 mL) | 6 | 97 |
| 6 | 6 | NaBH₄ (1.5) | THF (0.1 mL) | 6 | 78 |
| 7 | 12 | NaBH₄ (3.0) | THF (0.5 mL) | 4 | 30 (62)^{d} |
| 8^{e} | 6 | NaBH₄ (3.0) | — | 16 | 35 |

^{a}Reaction conditions: Nimodipine (208 mg, 0.5 mmol), 2 wt % TPGS-750-M /H₂O (1 mL), rt.
^{b}GC yield.
^{c}0.2 m scale.
^{d}over-reduction of the heterocyclic ring.
^{e}5 wt % TPGS-750-M /H₂O.

All optimization reactions were conducted using the general method unless noted. Yields were determined by GCMS using mesitylene as internal standard.

### General Experimental Details:

### Preparation of Substrates

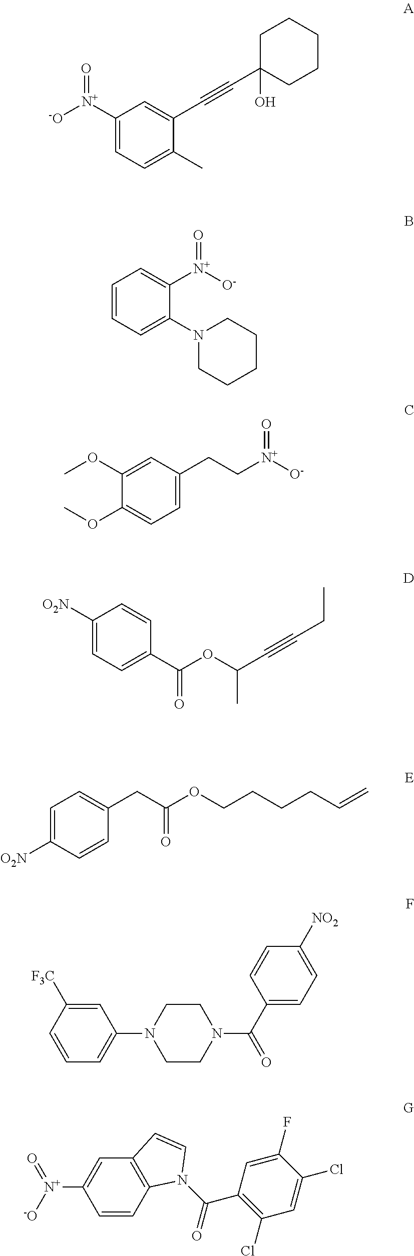

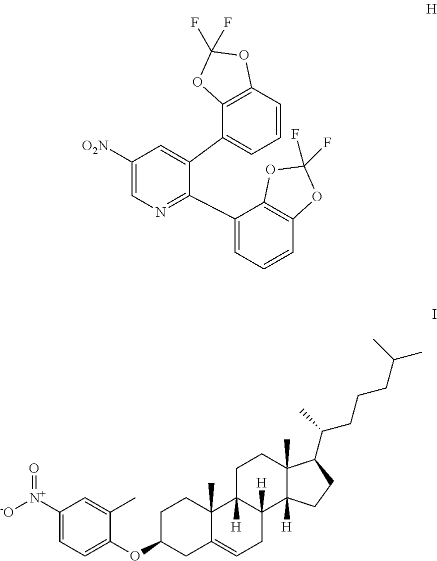

Substrate A was synthesized according to the literature; Substrate B was synthesized according to the literature; Substrate C was synthesized according to the literature; Substrate H was synthesized using Suzuki coupling; Substrate D-G and I was synthesized using the DCC procedure (see below).

General procedure for DCC Coupling:

To an oven-dried 50 mL RBF equipped with a Teflon coated stir bar, arylcarboxylic acid (5.0 mmol), aryl/alkyl amine or alcohol (6 mmol), and DMAP (30.5 mg, 0.25 mmol) were added. Dry CH₂Cl₂ (5.0 mL) was added. While maintaining a reaction temperature 0° C., DCC (1.3 g, 6.5 mmol) was added and the mixture was vigorously stirred and warmed to rt, and stirred for 3 h. After complete consumption of starting material (by TLC), the suspended solid was filtered off and washed with 10 mL CH₂Cl₂. The organic extracts were collected and diluted with CH₂Cl₂ (30 mL), then combined and washed with 1 M aqueous HCl (2×25 mL), NaHCO₃ and brine (2×30 mL). The organic layer was separated and dried over anhydrous Na₂SO₄. Volatiles were removed under reduced pressure to obtain crude product and purified by flash chromatography on silica gel with a gradient eluent using hexanes and EtOAc.

### General Procedure for Nitro Group Reductions:

Iron based nanomaterial (6 mg) was added to an oven dried 4 mL microwave reaction vial containing a PTFE-coated magnetic stir bar. The reaction vial was closed with a rubber septum and 0.5 mL aqueous solution of 2 wt. % TPGS -750-M was added via syringe. The mixture was stirred at RT for 1 min. NaBH₄ (28.5-59.0 mg, 0.75-1.50 mmol) was slowly added to the reaction mixture. (Caution—NaBH₄ should be added very slowly, especially for large scale reactions; i.e., >1 mmol). During addition of NaBH₄, the mixture turned black with evolution of hydrogen gas. The nitro group-containing substrate (0.5 mmol), pre-dissolved or dispersed in 0.5 mL aqueous TPGS-750-M in advance, for some substrates, the material was dissolved in minimum amount THF (160 μL for 78 mg of SM) and dispersed in 2 wt. % TPGS-750-M/H₂O (prior to addition) was then added to the catalyst suspension via canula. The reaction vial was filled with argon and covered with a rubber septum and stirred vigorously at rt. Progress of the reaction was monitored by TLC.

After complete consumption of starting material (by TLC), the septum was removed and argon was bubbled through the mixture. Minimal amounts of an organic solvent (EtOAc, i-PrOAc, Et₂O, MTBE etc.) were added, and the mixture was stirred for 2 min. Stirring was stopped and organic layer was then allowed to separate, and was removed via pipette. The same extraction procedure was repeated, and the combined organic extracts were dried over anhydrous Na₂SO₄. Volatiles were evaporated under reduced pressure and product was purified by flash chromatography over silica gel. Caution: Never use acetone for TLC monitoring or column chromatography. The reaction tube sometimes needs to be shaken to avoid adherence of reaction material to the glass tube.

Alternatively, the product can be extracted with ether and purified by making its HCl salt in ethereal solution, especially in cases of low boiling or highly volatile products.

### Procedure for In Situ Amine Generation and Protection:

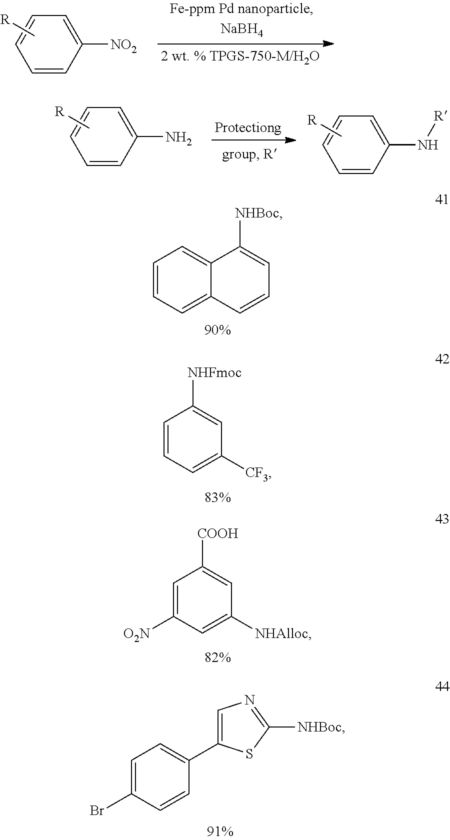

Iron-ppm Pd based nanomaterial (6 mg, 1.8%) was placed into an oven dried 4 mL microwave reaction vial containing a PTFE-coated magnetic stir bar. The reaction vessel was closed with a rubber septum, and 0.5 mL aqueous solution of 2 wt % TPGS-750-M was added via syringe. The mixture was stirred at RT for 1 min. The septum was then opened and NaBH₄ (28.5 mg, 0.75 mmol) was slowly added to the reaction mixture. (Caution—Add NaBH₄ very slowly). During addition of NaBH₄, the reaction mixture turned black with evolution of hydrogen gas. The nitro-containing compound (0.5 mmol pre-dissolved or dispersed in 0.5 mL aqueous TPGS-750-M in advance) was then added to the catalyst suspension via canula. The reaction vial was filled argon and covered with a rubber septum and the contents stirred vigorously at rt and monitored by TLC. After complete consumption of starting material (TLC), the amino protecting reagent (1.1 equiv for products 41-43, 2.5 equiv for product 44) and triethylamine (50 mg, 0.5 mmol) was added portion-wise to the reaction mixture, and the resulting slurry was further stirred vigorously at RT overnight. The mixture was then extracted with EtOAc (0.3 mL×2), and the combined organic extracts were dried over anhydrous Na₂SO₄. Volatiles were removed under reduced pressure to obtain crude material that was either purified by flash chromatography over silica gel or recrystallized in methanol.

### Procedure for 1-Pot Nitro Group Reduction and Oxidative Cyclization:

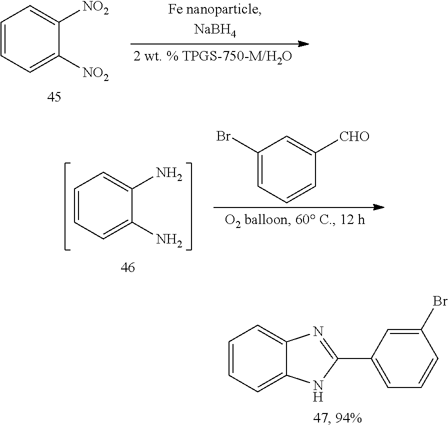

Iron-ppm Pd based nanomaterial (12.4 mg, 3.6%) was placed into an oven dried 4 mL microwave reaction vial containing a PTFE-coated magnetic stir bar. The reaction vial was closed with a rubber septum and 0.5 mL aqueous solution of 2 wt % TPGS-750-M was added via syringe, and stirred at rt for 1 min. The septum was removed and NaBH₄ (114 mg, 3 mmol) was slowly added to the reaction mixture. During addition of NaBH₄, the reaction mixture turned black with evolution of hydrogen gas. 1, 2-Dinitrobenzene (84 mg, 0.5 mmol), dispersed in 0.5 mL of aqueous TPGS-750-M in advance, was then added to the catalyst suspension via canula. The reaction vial was filled argon and covered again with a rubber septum and the mixture was vigorously stirred for about 2 h until complete consumption of starting material. The resulting mixture was neutralized with 1 M HCl. 3-Bromobenzaldehyde (90 mg, 0.48 mmol) was added and the vessel was purged with oxygen with oxygen balloon. The contents were vigorously stirred at 60° C. for 12 h. After the reaction was complete, the mixture was extracted with EtOAc (0.3 mL×2). The organic extracts were removed under reduced pressure and purified by flash chromatography over silica gel with EtOAc/hexanes (10/90) to obtain pure 2-(3-bromophenyl)-1H-benzo[d]imidazole 47 (127 mg, 0.47 mmol, 94%). Spectral data matched that reported in the literature. GCMS, m/z: 272 [M⁺].

### Procedure for the synthesis of methyl 3-amino-5-(2-(4-methoxyphenyl) acetamido)benzoate 36:

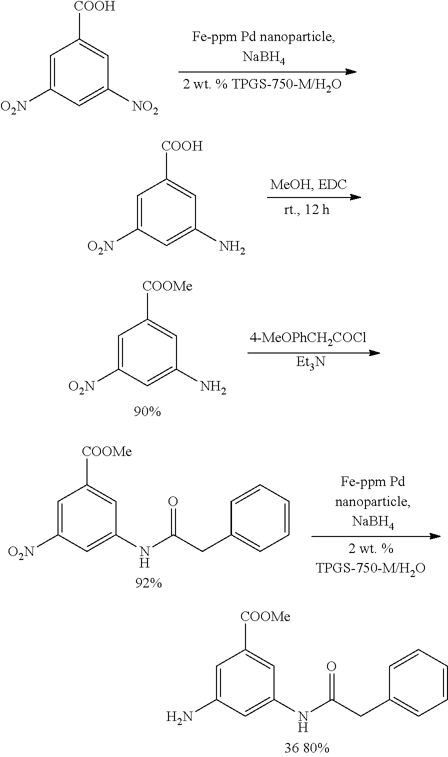

### Procedure for the synthesis of 3-amino-5-nitrobenzoate

Iron based nanomaterial (12.4 mg, 3.6%) was placed into an oven dried 4 mL microwave reaction vial containing a PTFE-coated magnetic stir bar. The reaction vial was closed with a rubber septum and 0.5 mL aqueous solution of 2 wt % TPGS-750-M was added via syringe. The mixture was stirred at RT for 1 min. The septum was removed and NaBH₄ (21 mg, 0.55 mmol) was slowly added to the mixture. (Caution—NaBH₄ should be added very slowly, especially for large scale reactions). During addition of NaBH₄, the reaction turned black with evolution of hydrogen gas. 3,5-Dinitrobenzoic acid (106 mg, 0.5 mmol, dispersed in 0.5 mL aqueous TPGS-750-M in advance) was added to the catalyst suspension via canula. The reaction vial was filled with argon and covered, and stirred at rt for 1 h, and monitored by TLC. After complete consumption of starting material (TLC), and the mixture was extracted with EtOAc (1 mL×3), the combined organic extracts were concentrated under vacuum to obtain a yellowish solid (contains 5% over-reduced product). The resulting solid was placed into another oven dried 4 mL microwave reaction vial containing methanol (1 mL), EDC (114 mg, 0.6 mmol), and DMAP (1 mg, 0.01 mmol). The mixture was stirred at rt for 6 h. After reaction completion, the mixture was washed with dilute HCl (1 M, 1 mL×3), saturated NaHCO₃ and then brine. The combined organic extracts were dried over anhydrous Na₂SO₄. Volatiles were removed under reduced pressure to obtain crude product that was purified by flash chromatography over silica gel with EtOAc/hexanes (15/85) to obtain pure 3-amino-5-nitrobenzoate (88 mg, 0.42 mmol, 84%). ¹H NMR (500 MHz, CDCl₃) δ 8.20 (s, 1H), 7.66 (s, 1H), 7.62 (s, 1H), 3.95 (s, 3H); ¹³C NMR (126 MHz, CDCl₃) δ 165.28, 149.28, 147.32, 132.43, 121.21, 114.25, 112.83, 52.66; GC-MS, m/z: 196 [M⁺].

### Procedure for the Synthesis of Product 36:

To a separate oven-dried sample vial equipped with Teflon coated stir bar, 3-amino-5-nitrobenzoate (49 mg, 0.25 mmol), triethylamine (33 mg, 0.33 mmol), CH₂Cl₂ (1 mL) were sequentially added. The resulting solution was cooled to 0° C. and 2-(4-methoxyphenyl)acetyl chloride (46 mg, 0.25 mmol) was added dropwise to the reaction mixture, then slowly warmed to rt and stirred for 2 h. After the reaction, H₂O (1 mL) was added, the organic phase was separated and the volatiles were removed under vacuum. To the residue was transferred iron nanomaterial (12 mg, 0.8%) and 2 wt % TPGS-750-M (1 mL), and stirred at rt for 1 min. The septum was removed and NaBH₄ (21 mg, 0.55 mmol) was slowly added to the reaction mixture. During addition of NaBH₄, the reaction mixture turned black with evolution of hydrogen gas. The vial was covered and the contents stirred vigorously for 8 h. The mixture was then extracted with EtOAc (0.3 mL×2), concentrated in vacuo, and purified by flash chromatography over silica gel with EtOAc/hexanes (15/85 to 30/70) to yield methyl 3-amino-5-(2-(4-methoxyphenyl)acetamido)benzoate 56 (63 mg, 0.2 mmol, 80%) as a colorless oil; Spectral data matched the literature. GC-MS, m/z: 314 [M⁺].

E Factor and Recycle Studies:

Reactions were run on a 1 mmol scale according to the procedure outlined above for recycling of the reaction medium.

$$\begin{matrix}E Factor = ( mass organic waste ) / ( mass of pure product ) \\ = ( mass EtOAc / ( mass pure product ) \\ = ( 717 mg EtOAc ) / ( 150.7 mg pure product ) \\ = 4.8\end{matrix}$$

$$Including water in the reaction medium$$

$$\begin{matrix}E Factor = ( mass organic waste ) / ( mass of pure product ) \\ = ( 717 mg EtOAc + 1000 mg water ) / ( 150.7 mg pure ) \\ = 11.4\end{matrix}$$

Iron based nanomaterial (12 mg, 3.6%) was placed into an oven dried 5 mL microwave reaction vial containing a PTFE-coated magnetic stir bar. The reaction vial was covered with a rubber septum and 0.5 mL aqueous solution of 2 wt. % TPGS-750-M was added via syringe. The mixture was stirred at rt for 1 min. The septum was opened and NaBH₄ (57 mg, 1.5 mmol) was slowly added to the mixture. During addition NaB H₄, reaction mixture was turned black with evolution of hydrogen gas. 1-Chloro-2-methoxy-4-nitrobenzene (187 mg, 1 mmol) was then added and the vial was filled argon and again covered. The contents were stirred vigorously until complete consumption of the starting material (about 4 h). The resulting mixture was extracted with EtOAc (0.4 mL×2). The organic layer was then separated (with the aid of centrifuge, if needed) and dried over anhydrous Na₂SO₄, and the volatiles were removed under reduced pressure and purified by flash chromatography over silica gel with EtOAc/hexanes to obtain 4-chloro-3-methoxyaniline 54 (151 mg, 0.96 mmol, 96%). Brown solid, mp 79-80° C.; ¹H NMR (400 MHz, DMSO) δ 6.98 (d, J=8.4, 1H), 6.34 (d, J=1.8, 1H), 6.16 (dd, J=8.4, 1.9, 1H), 5.23 (s, 2H), 3.74 (s, 3H). GC-MS, m/z: 157 [M⁺].

For the recycling studies, the aqueous layer from above was neutralized carefully (pH=7-8) by addition with a few drops of (1 M) aqueous hydrochloric acid solution. A solution of 2 wt % TPGS-750-M (0.3 mL in water), and fresh Fe nanoparticles (3 mg) were added via syringe, followed by NaBH₄ (57 mg, 1.5 mmol). During addition of NaBH₄, reaction mixture turned black with evolution of hydrogen gas. 1-Chloro-2-methoxy-4-nitrobenzene (187 mg, 1 mmol) was added and the vial was covered and stirred vigorously at rt for 4 h. The extraction cycle was repeated. Yield 151 mg (96%). The surfactant/H₂O can be recycled at least four times without significant loss of catalytic reactivity.

### Procedure for 1-Pot Nitro Group Reduction and Amidation, and E Factor Study:

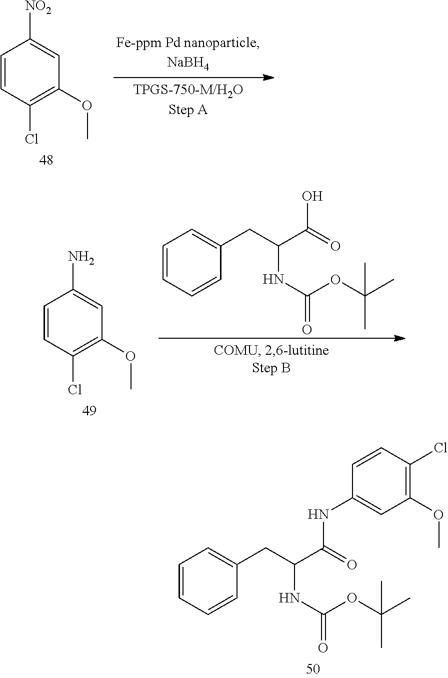

Iron based nanomaterial (12 mg, 3.2%) was placed into an oven dried 5 mL microwave reaction vial containing a PTFE-coated magnetic stir bar. The reaction vial was closed with a rubber septum and 0.5 mL aqueous solution of 2 wt % TPGS-750-M was added via syringe. The mixture was stirred at rt for 1 min. The septum was opened and NaBH₄ (57 mg, 1.5 mmol) was slowly added to the reaction mixture. During addition of NaBH₄, the reaction mixture turned black with evolution of hydrogen gas. 1-Chloro-2-methoxy-4-nitrobenzene (187 mg, 1 mmol) was then added and the vial was filled argon and covered. The contents were stirred vigorously until complete consumption of the starting material (about 4 h). Diluted hydrochloric acid (1 M) was added dropwise to adjust the pH to 7-8. N-Boc-L-phenylalanine (265 mg, 1 mmol), (1-cyano-2-ethoxy-2-oxoethylidenaminooxy) dimethylamino-morpholino-carbenium hexafluorophosphate (COMU) (470 mg, 1.1 mol), and 2,6-lutidine (350 mg, 3.2mmol) were added. The mixture was stirred at rt until consumption of aniline. Stirring was stopped, and the mixture was extracted with EtOAc (0.3 mL×2), washed with 1 M hydrochloric acid (0.2 mL), and with saturated aqueous NaHCO₃ (0.2 mL). The organic phase was concentrated in vacuo and purified by flash chromatography over silica gel yielding t-butyl (1-((4-chloro-phenyl)amino)-1-oxo-3-phenylpropan-2-yl)carbamate 55 as off-white semi-solid (282 mg, 0.76 mmol, 75%). ¹H NMR (500 MHz, CDCl₃) δ 8.43 (s, 1H), 7.36-7.18 (m, 6H), 7.15 (d, J=8.5 Hz, 1H), 6.71 (dd, J=8.5, 1.9 Hz, 1H), 5.29 (t, J=3.8 Hz, 1H), 4.56 (s, 1H), 3.81 (s, 3H), 3.11 (ddd, J=21.7, 13.9, 7.2 Hz, 2H); HRMS (EI): Calcd. For C₂₁H₂₅ClN₂O₄ (M)⁺404.1503. Found: 404.1497.

$$\begin{matrix}E Factor = ( mass organic waste ) / ( mass of pure product ) \\ = ( 717 + 400 + 400 mg ) / ( 303 mg pure product ) \\ = 5.0\end{matrix}$$

$$Including water in the reaction medium$$

$$\begin{matrix}E Factor = ( mass organic waste ) / ( mass of pure product ) \\ = ( 717 + 400 + 400 + 1000 mg of water ) / ( 303 mg pure ) \\ = 8.3\end{matrix}$$

### 4.8 Procedure for 1-Pot Three Steps Nitro-Reduction, Amidation, Suzuki Tandem Reaction:

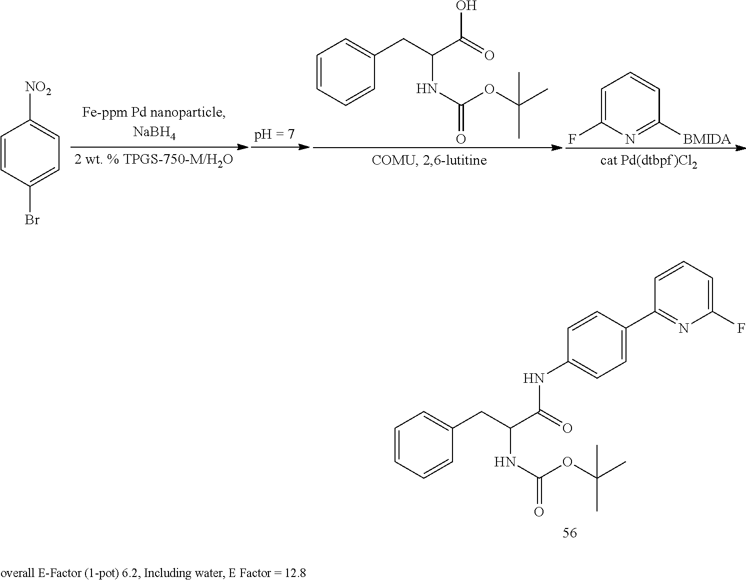

The reduction and amidation procedures shown above are as follows. To an oven-dried sample vial with a Teflon coated stir bar was added iron nanoparticles (10 mg, 3%). 2 wt % TPGS-750-M in water (1 mL) was transferred to the mixture. The mixture was vigorously stirred for 2 min. To the resultant suspension was added NaBH₄ (28.5 mg, 0.75 mmol) slowly. The mixture turned black with bubbles at the top. 4-Bromonitrobenzene (100 mg, 0.5 mmol) was added and the vial was filled argon and covered and the contents stirred vigorously until full consumption of the substrate (about 4 h). Dilute HCl (1 M) was added dropwise to adjust the pH to 7-8. COMU (235 mg, 0.55 mol) and 2,6-lutidine (175 mg, 1.6 mmol) were added, and the mixture was stirred at 45° C. for 16 h. 2-(6-Fluoropyridin-2-yl)-6-methyl-1,3,6,2-dioxazaborocane-4,8-dione (126 mg, 0.5 mmol) and Pd(dtpbf)Cl₂ (3 mg) were added, and the suspension was degassed with argon and stirred in an inert atmosphere at 45° C. for 16 h. Upon completion, the mixture was extracted with EtOAc (0.3 mL×2), washed with 1M HCl (0.2 mL), and saturated NaHCO₃ solution (0.2 mL). The organic phase were concentrated in vacuo and purified by flash chromatography over silica gel to give t-butyl (S)-(1-((4-(6-fluoropyridin-2-yl)phenyl)amino)-1-oxo-3-phenylpropan-2-yl)carbamate 52 as a white semi-solid (152 mg, 0.35 mmol, 70%). ¹H NMR (500 MHz, CDCl₃) δ 8.32 (s, 1H), 7.88 (d, J=7.2 Hz, 2H), 7.77 (dd, J=15.8, 7.9 Hz, 1H), 7.52 (d, J=6.2 Hz, 1H), 7.47 (d, J=8.5 Hz, 2H), 7.27 (dt, J=8.4, 7.0 Hz, 5H), 6.84-6.75 (m, 1H), 5.33 (s, 1H), 4.58 (s, 1H), 3.21-3.08 (m, 2H), 1.42 (s, 9H); HRMS (EI): Calcd. For C₂₅H₂₆FN₃O₃ (M)⁺435.1958. Found: 435.1949.

### H/D Transfer Experiment and Controlled Experiment:

### H/D Transfer Experiments:

As the proton of aniline is active, the proton NMR does not show any positive result, the H/D experiment was taken using MS spectra according to the molecular ion peak intensity. The H/D exchange is quick when aniline was put in D₂O (Eqn. C), however, when the nitro group reduction was conducted in D₂O, the main product is still aniline instead of deuterated aniline, which indicates that the proton mainly comes from NaBH₄.

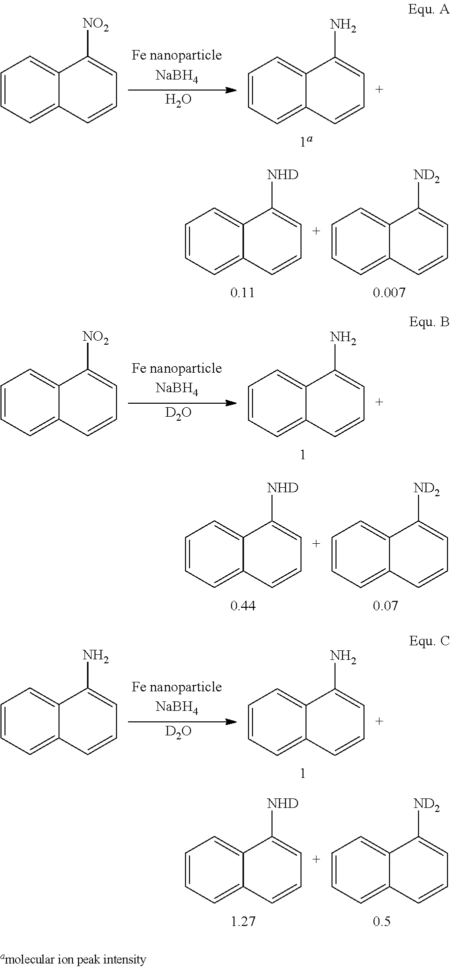

### Control Experiments

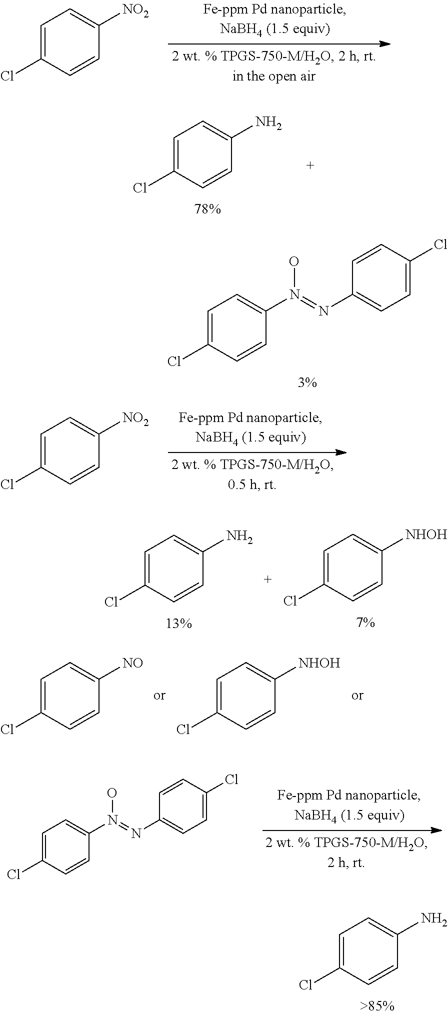

All the controlled experiments were conducted using general method. The yield was based on GC-MS.

### Analysis for Residual Palladium in Selected Products:

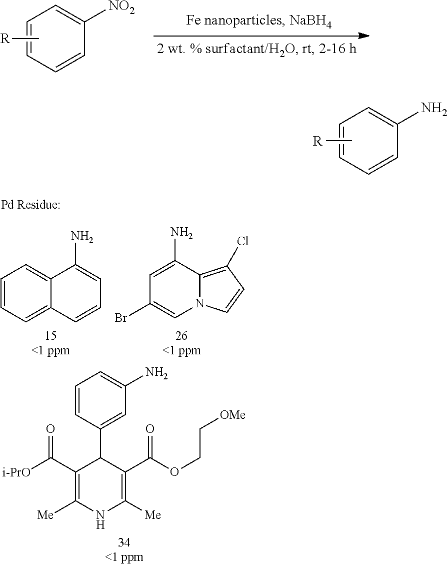

### ICP-MS for Pd Nanoparticles:

| Samples | ICP-MS¹; % Pd |
|---|---|
| REILLJO3-001-EXP054-001 | <1 ppm |
| REILLJO3-001-EXP055-001 | <1 ppm |
| REILLJO3-001-EXP056-001 | <1 ppm |

¹Results from Robertson Microlit Laboratories, Cambridge Mass.

### General Experimental Details:

Substrate scope of nitro-reductions^{a,b}

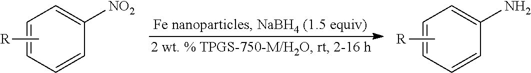

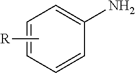

1 R = —Cl 90%
2 R = —CHO 76%^{[c]}
3 R = —COOMe 93%
4 R = —COOH 80%
5 R = —CN 96%
6R = —Br 88%
7 R = —I 66%
8 R = —SMe 94%

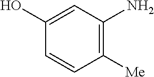

9 2 h, 91%

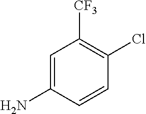 [SMILES: Nc1ccc(Cl)c(C(F)(F)F)c1]

10 2 h, 94%

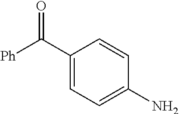 [SMILES: Nc1ccc(C(=O)c2ccccc2)cc1]

11 4 h, 82% ^{[c]}

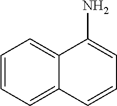 [SMILES: Nc1cccc2ccccc12]

12 2 h, 98%

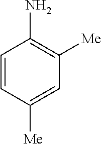

13 4h, 94%

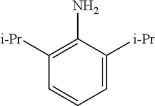 [SMILES: CC(C)c1cccc(C(C)C)c1N]

14 16 h, 88%

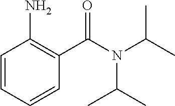 [SMILES: CC(C)N(C(=O)c1ccccc1N)C(C)C]

15 16 h, 90%

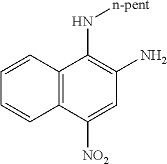

16 4 h, 70% ^{[d]}

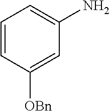 [SMILES: Nc1cccc(OCc2ccccc2)c1]

17 2 h, 90%

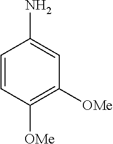 [SMILES: COc1ccc(N)cc1OC]

18 8 h, 93%

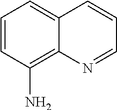 [SMILES: Nc1cccc2cccnc12]

19 2 h, 92%

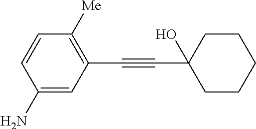 [SMILES: Cc1ccc(N)cc1C#CC1(O)CCCCC1]

20 1.5 h, 75% ^{c}

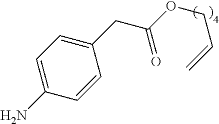

21 16 h, 87% ^{e}

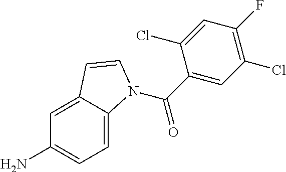 [SMILES: Nc1ccc2c(ccn2C(=O)c2cc(Cl)c(F)cc2Cl)c1]

22 2 h, 97%

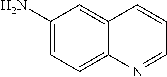 [SMILES: Nc1ccc2ncccc2c1]

23 2 h, 95%

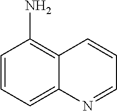 [SMILES: Nc1cccc2ncccc12]

24 2 h, 90%

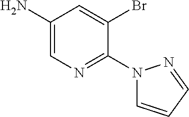 [SMILES: Nc1cnc(-n2cccn2)c(Br)c1]

25 4h, 96% ^{d}

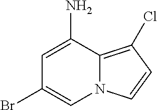 [SMILES: Nc1cc(Br)cn2ccc(Cl)c12]

26 16 h, 80%

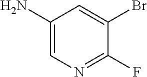

27 4 h, 98%

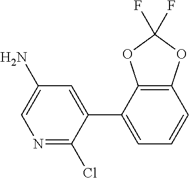 [SMILES: Nc1cnc(Cl)c(-c2cccc3c2OC(F)(F)O3)c1]

28 6 h, 95%

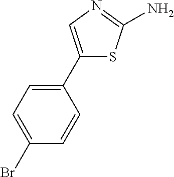 [SMILES: Nc1ncc(-c2ccc(Br)cc2)s1]

29 13 h, 93%

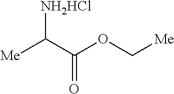

30, 2 h, 91%

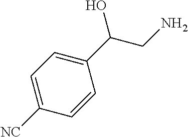 [SMILES: N#Cc1ccc(C(O)CN)cc1]

31, 0.5 h, 0% (98%^{f})

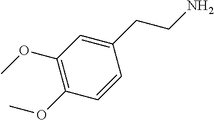

32 4 h, 82%

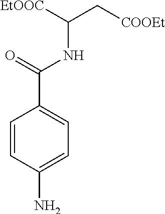 [SMILES: CCOC(=O)CC(NC(=O)c1ccc(N)cc1)C(=O)OCC]

33 6 h, 86% ^{d,e}

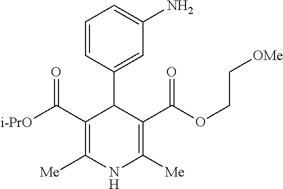

34 6 h, 90% ^{g}

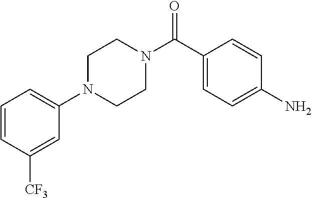 [SMILES: Nc1ccc(C(=O)N2CCN(c3cccc(C(F)(F)F)c3)CC2)cc1]

35 16 h, 82% ^{d,e}

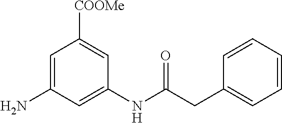 [SMILES: COC(=O)c1cc(N)cc(NC(=O)Cc2ccccc2)c1]

36 4 step synthesis, 80% ^{h}

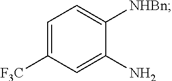

37 12 h, 80%

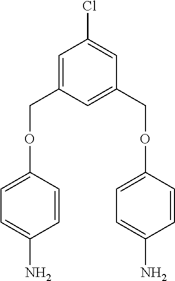 [SMILES: Nc1ccc(OCc2cc(Cl)cc(COc3ccc(N)cc3)c2)cc1]

38 18 h, 77% ^{d,e}

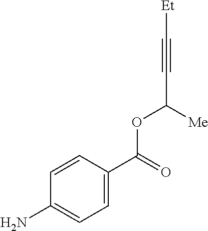 [SMILES: CCC#CC(C)OC(=O)c1ccc(N)cc1]

39 6 h, 90% ^{d,e}

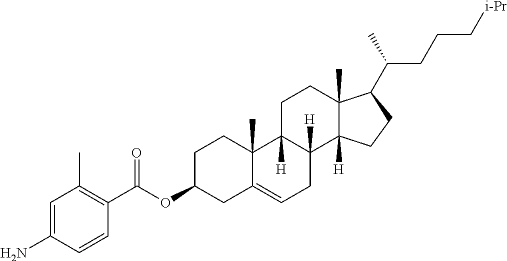

40 16 h, 79% ^{g}
^{a}Reaction conditions: nitro compound (0.5 mmol, 1 equiv), Fe nanoparticles (6 mg, 0.4%), NaBH₄ (0.75 mmol, 1.5 equiv), 2 wt % TPGS-750-M/H₂O 1 mL;
^{b}Isolated yield;
^{c} NaBH₄ (0.55 mmol, 1.1 equiv);
^{d} Fe nanoparticles (12 mg, 0.8%);
^{e} NaBH₄ (1.5 mmol, 3 equiv);
^{f}The yield of 4-(hydroxymethyl)benzonitrile;
^{g} Fe nanoparticles (12 mg, 0.4%), NaBH₄ (1.5 mmol, 3 equivs), addition of 0.1 mL THF;
^{h}1 g scale.

Reduction Using Fe-Pd Nanoparticles and Ni-doped Nanoparticles: As shown in the results below, nanoparticles that contain both Pd and Ni combination are typically faster than the reaction using the nanoparticles with Pd only.

| | | | |
|---|---|---|---|
| | 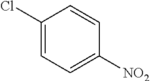 | 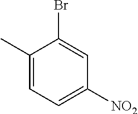 | 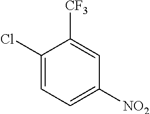 [SMILES: O=[N+]([O-])c1ccc(Cl)c(C(F)(F)F)c1] |
| original Fe/ppm Pd NPs | 2 h, 90% | 1.5 h, 96% | 2 h, 94% |
| new Ni-doped NPs | 15 min, 92% | 30 min, 82% | 30 min, 98% |

| | | |
|---|---|---|
| | 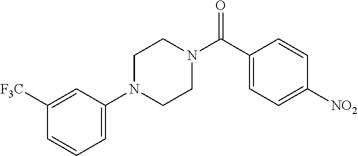 [SMILES: O=C(c1ccc([N+](=O)[O-])cc1)N1CCN(c2cccc(C(F)(F)F)c2)CC1] | 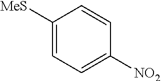 [SMILES: CSc1ccc([N+](=O)[O-])cc1] |
| original Fe/ppm Pd NPs | 8 h, 90% | 12 h, 72% |
| new Ni-doped NPs | 2 h, 88% | 2 h, 88% |

### Analytical Data

For simple aryl amines 1-8, ¹H NMR and MS data were given which was consistant with the literature. For all the unknown amines ¹H NMR, ¹³C NMR, ¹⁹F NMR and HRMS data were given.

### 3-Amino-4-methylphenol (9) CAS:2836-00-2

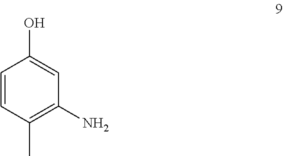

4-Methyl-3-nitrophenol (77 mg, 0.50 mmol), Fe nano particles (6 mg), and NaBH₄ (29 mg, 0.75 mmol) in 1.0 mL 2 wt. % TPGS/H₂O were reacted at rt for 2 h yielding 56 mg (91%) of 3-amino-4-methylphenol as a white solid (hexane/ethyl acetate: 50/50). Melting point: 154° C.-156° C. Spectral data matched the literature. GC-MS, m/z: 123 [M⁺].

### 4-Chloro-3-(trifluoromethyl)aniline (10) CAS:320-51-2

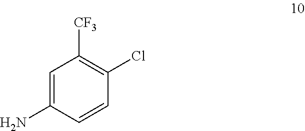 [SMILES: Nc1ccc(Cl)c(C(F)(F)F)c1]

1-Chloro-4-nitro-2-(trifluoromethyl)benzene (113 mg, 0.50 mmol), Fe nano particles (6 mg), and NaBH₄ (28.5 mg, 0.75 mmol) in 1.0 mL 2 wt. % TPGS/H₂O were reacted at rt for 2 h yielding 91.7 mg (94%) of 4-chloro-3-(trifluoromethyl)aniline as a colorless oil (hexane/ethyl acetate: 80/20). Spectral data matched the literature. GC-MS, m/z: 195 [M⁺].

### 2,6-Diisopropylaniline (14) CAS:24544-04-5

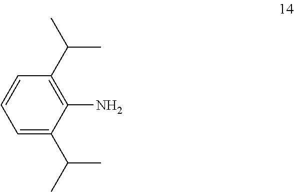

1,3-Diisopropyl-2-nitrobenzene (104 mg, 0.50 mmol), Fe nano particles (6 mg), and NaBH₄ (38 mg, 1 mmol) in 1.0 mL 2 wt. % TPGS/H₂O were reacted at rt for 16 h yielding 78 mg (88%) of 2,6-diisopropylaniline as a colorless oil (hexane/ethyl acetate: 80/20). GC-MS, m/z: 177 [M⁺].

### 2-(Piperidin-1-yl)aniline (15)CAS# 103794-66-7

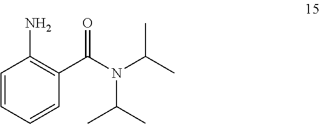 [SMILES: CC(C)N(C(=O)c1ccccc1N)C(C)C]

N,N-diisopropyl-2-nitrobenzamide (125 mg, 0.50 mmol), Fe nano particles (6 mg), and NaBH₄ (28.5 mg, 0.75 mmol) in 1.0 mL 2 wt. % TPGS/H₂O were reacted at rt for 16 h yielding 85.8 mg (78%) of 2-amino-N,N-diisopropylbenzamide as a colorless oil (ether/ethyl acetate: 50/50). Spectral data matched the literature. GC-MS, m/z: 220[M⁺].

### 4-Nitro-N-pentylnaphthalene-1,2-diamine (16)

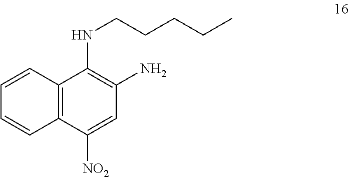 [SMILES: CCCCCNc1c(N)cc([N+](=O)[O-])c2ccccc12]

2,4-Dinitro-N-pentylnaphthalen-1-amine (152 mg, 0.50 mmol), Fe nano particles (10 mg), and NaBH₄ (38 mg, 1 mmol) in 1.0 mL 2 wt. % TPGS/H₂O were reacted at rt for 4 h yielding 95.5 mg (70%) of 4-nitro-N-pentylnaphthalene-1,2-diamine as brown oil (hexane/ethyl acetate: 70/30). HRMS(EI): Calcd. For C₁₅H₁₉N₃O₂ (M)⁺273.1475. Found: 273.1477.

### 3,4-Difluoroaniline (13) CAS:3863-11-4

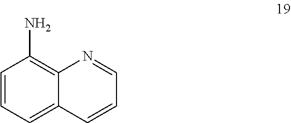 [SMILES: Nc1cccc2cccnc12]

8-Nitroquinoline (87 mg, 0.50 mmol), Fe nano particles (6 mg), and NaBH₄ (29 mg, 0.75 mmol) in 1.0 mL 2 wt. % TPGS/H₂O were reacted at rt for 2 h yielding 63 mg (88%) of 3,4-quinolin-8-amine as a white solid (hexane/ethyl acetate: 70/30). Melting point: 65° C. -67° C. Spectral data matched the literature.

### 1-((5-Amino-2-methylphenyl)ethynyl)cyclohexan-1-ol (20)

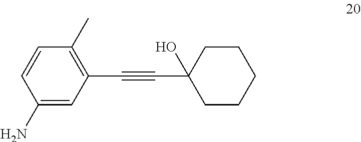 [SMILES: Cc1ccc(N)cc1C#CC1(O)CCCCC1]

1-((5-Nitro-2-methylphenyl)ethynyl)cyclohexan-1-ol (135 mg, 0.50 mmol), Fe nanoparticles (6 mg), and NaBH₄ (21 mg, 0.55 mmol) in 1.0 mL 2 wt % TPGS/H₂O were reacted at rt for 1.5 h gave 86 mg (75%) of 1-((5-amino-2-methylphenyl)ethynyl) cyclohexan-1-ol as a yellow oil (R_{f}=0.3, hexane/ether: 50/50). ¹H NMR (500 MHz, CD₃OD) δ 6.94 (d, J=8.2 Hz, 1H), 6.76 (d, J=1.7 Hz, 1H), 6.62 (dd, J=8.1, 2.4 Hz, 1H), 2.28 (s, 3H), 2.01-1.93 (m, 2H), 1.74 (dd, J=11.5, 6.4 Hz, 2H), 1.68-1.54 (m, 6H). HRMS(EI): Calcd. For C₁₅H₁₉NO (M)⁺229.1467. Found: 229.1474.

### Hex-5-en-1-yl 2-(4-aminophenyl)acetate (21) CAS #917509-94-5

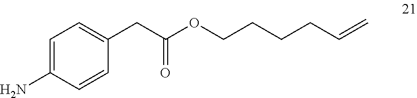 [SMILES: C=CCCCCOC(=O)Cc1ccc(N)cc1]

Hex-5-en-1-yl 2-(4-nitrophenyl)acetate (132 mg, 0.50 mmol), Fe nano particles (7.5 mg), and NaBH₄ (28.5 mg, 0.75 mmol) in 1.0 mL 2 wt % TPGS/H₂O were reacted at rt for 16 h yielding 101 mg (87%) of hex-5-en-1-yl 2-(4-aminophenyl)acetate as a colorless oil(hexane/ethyl acetate: 85/15). Spectral data matched the literature. GC-MS, m/z: 233 [M⁺].

### (5-Amino-1H-indol-1-yl)(2,5-dichloro-4-fluorophenyl)methanone (22)

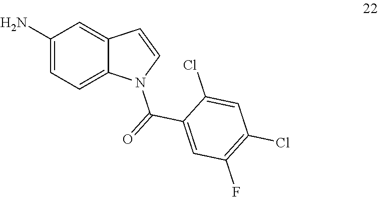 [SMILES: Nc1ccc2c(ccn2C(=O)c2cc(F)c(Cl)cc2Cl)c1]

(2,5-Dichloro-4-fluorophenyl)(5-nitro-1H-indol-1-yl)methanone (105 mg, 0.30 mmol), Fe nanoparticles (6 mg), and NaBH₄ (28.5 mg, 0.75 mmol) in 1.0 mL 2 wt % TPGS/H₂O reacted at rt for 4 h yielding 93.7 mg (97%) of (5-amino-1H-indol-1-yl) (2,5-dichloro-4-fluorophenyl)methanone as a colorless oil (R_{f}=0.27, hexane/ethyl acetate: 70/30). ¹H NMR (500 MHz, DMSO) δ 8.03 (d, J=6.5 Hz, 2H), 7.95 (d, J=8.9 Hz, 1H), 7.01 (s, 1H), 6.73 (d, J=2.0 Hz, 1H), 6.65 (d, J=8.1 Hz, 1H), 6.51 (d, J=3.4 Hz, 1H), 5.06 (s, 2H). HRMS(EI): Calcd. For C₁₅H₁₉NO (M)⁺322.0076. Found: 322.0085

### 5-Bromo-6-(1H-pyrazol-1-yl)pyridin-3-amine (25) CAS #1522912-84-0

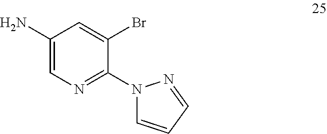 [SMILES: Nc1cnc(-n2cccn2)c(Br)c1]

3-Bromo-5-nitro-2-(1H-pyrazol-1-yl)pyridine (134 mg), Fe nano particles (6 mg), and NaBH₄ (23 mg, 0.6 mmol) in 1.0 mL 2 wt % TPGS/H₂O were reacted at rt for 4 h yielding 114 mg (96%) of 5-bromo-6-(1H-pyrazol-1-yl)pyridin-3-amine as a colorless oil (R_{f}=0.5, hexane/ethyl acetate: 60/40). ¹H NMR (500 MHz, CDCl₃) δ 8.49 (d, J=2.5 Hz, 1H), 7.81 (d, J=1.9 Hz, 1H), 7.70 (s, 1H), 7.23 (d, J=1.9 Hz, 1H), 6.49-6.39 (m, 1H), 5.55 (brs, 2H). HRMS(EI): Calcd. For C₈H₇BrN₄ (M)⁺237.9854/237.9834. Found: 237.9847/237.9826.

### 6-Bromo-1-chloroindolizin-8-amine (26)

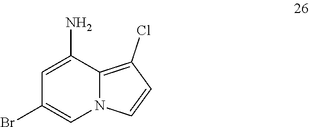 [SMILES: Nc1cc(Br)cn2ccc(Cl)c12]

6-Bromo-1-chloro-8-nitroindolizine (137 mg), Fe nano particles (6 mg), and NaBH₄ (23 mg, 0.75 mmol) in 1.0 mL 2 wt % TPGS/H₂O were reacted at rt for 16 h yielding 98 mg (80%) of 5-bromo-6-(1H-pyrazol-1-yl)pyridin-3-amine as a colorless oil (R_{f}=0.64, hexane/ethyl acetate: 70/30). ¹H NMR (500 MHz, DMSO) δ 8.31 (d, J=1.6 Hz, 1H), 7.38 (d, J=1.6 Hz, 1H), 6.92 (s, 1H), 5.38 (s, 2H). HRMS(EI): Calcd. For C₈H₇BrN₄ (M)⁺243.9403/245.9382. Found: 243.9409/245.9390.

### 5-Bromo-6-fluoropyridin-3-amine (27) CAS #209328-99-4

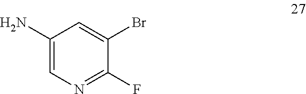

3-Bromo-2-fluoro-5-nitropyridine (110 mg, 0.5 mmol), Fe nano particles (6 mg), and NaBH₄ (22.8 mg, 0.75 mmol) in 1.0 mL 2 wt % TPGS/H₂O were reacted at rt for 4 h 93.1 mg (98%) of 5-bromo-6-(1H-pyrazol-1-yl)pyridin-3-amine as a colorless oil (R_{f}=0.12, hexane/ethyl acetate: 70/30). ¹H NMR (500 MHz, CDCl₃) δ 7.57-7.51 (m, 1H), 7.30 (dd, J=7.3, 2.7 Hz, 1H), 3.52 (s, 2H). GC-MS, m/z: 190 [M⁺].

### 6-Chloro-5-(2,2-difluorobenzo[d][1,3]dioxol-4-yl)pyridin-3-amine (28)

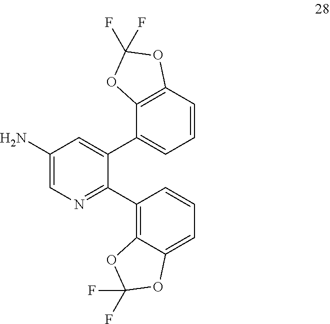 [SMILES: Nc1cnc(-c2cccc3c2OC(F)(F)O3)c(-c2cccc3c2OC(F)(F)O3)c1]

2,3-bis(2,2-difluorobenzo[d][1,3]dioxol-4-yl)-5-nitropyridine (22 mg, 0.05 mmol), Fe nanoparticles (1.5 mg), and NaBH₄ (4 mg, 0.1 mmol) in 0.2 mL 2 wt % TPGS/H₂O in a 1 mL vial were reacted at rt for 6 h yielding16 mg (77%) of 5,6-bis(2,2-difluorobenzo[d][1,3]dioxol-4-yl)pyridin-3-amine as a light yellow oil (R_{f}=0.22, hexane/ethyl acetate: 70/30). ¹⁹F NMR (376 MHz, CDCl₃) δ−50.70, −51.00. HRMS (EI): Calcd. For C₁₉H₁₀F₄N₂O₄ (M)⁺406.0577. Found: 406.0583.

### 5-(4-Bromophenyl)thiazol-2-amine (29) CAS #73040-60-5

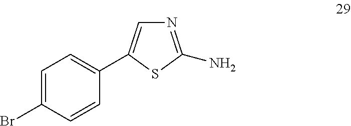 [SMILES: Nc1ncc(-c2ccc(Br)cc2)s1]

5-(4-Bromophenyl)-2-nitrothiazole (137 mg, 0.50 mmol), Fe nanoparticles (6 mg), and NaBH₄ (28.5 mg, 0.75 mmol) in 1.0 mL 2 wt. % TPGS/H₂O reacted at rt for 13 h yielding 114 mg (90%) of 5-(4-bromophenyl)thiazol-2-amine as a colorless oil (hexane/ethyl acetate: 85/15). Melting point: 203-206° C. GC-MS, m/z: 254 [M⁺].

### 2-(3,4-Dimethoxyphenyl)ethan-1-amine (32) CAS#120-20-7

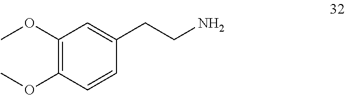

1,2-Dimethoxy-4-(2-nitroethyl)benzene (105 mg, 0.5 mmol), Fe nano particles (6 mg), and NaBH₄ (57 mg, 1.5 mmol) in 0.5 mL 2 wt. % TPGS/H₂O were reacted at rt for 16 h yielding 74 mg (82%) of 2-(3,4-dimethoxyphenyl)ethan-1-amine as an oil (R_{f}=0.51, hexane/EtOAc: 85/15). Spectral data matched the literature. GC-MS, m/z: 181 [M⁺].

### Diethyl (4-aminobenzoyl)glutamate (33) CAS #13726-52-8

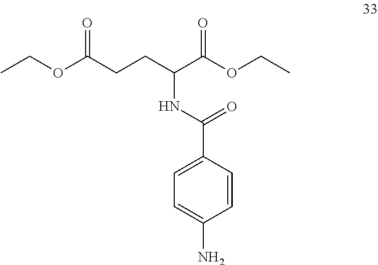 [SMILES: CCOC(=O)CCC(NC(=O)c1ccc(N)cc1)C(=O)OCC]

Diethyl (4-nitrobenzoyl)glutamate (176 mg, 0.5 mmol), Fe nano particles (6 mg), and NaBH₄ (28.5 mg, 0.75 mmol) in 1 mL 2 wt % TPGS/H₂O were reacted at rt for 6 h yielding 139 mg (86%) of diethyl (4-aminobenzoyl)glutamate as a grey solid (R_{f}=0.3, hexane/ethyl acetate: 60/40). Spectral data matched the literature. GC-MS, m/z: 322 [M⁺].

### 3-Isopropyl 5-(2-methoxyethyl) 4-(3-aminophenyl)-2,6-dimethylpyridine-3,5-dicarboxylate (34)

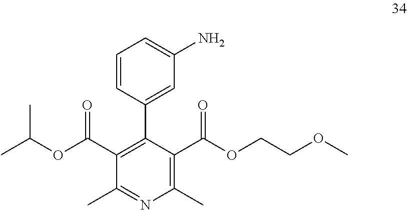 [SMILES: COCCOC(=O)c1c(C)nc(C)c(C(=O)OC(C)C)c1-c1cccc(N)c1]

3-Isopropyl 5-(2-methoxyethyl) 2,6-dimethyl-4-(3-nitrophenyl)pyridine-3,5-dicarboxylate (208 mg, 0.5 mmol), Fe nano particles (12 mg), and NaBH₄ (57 mg, 1.5 mmol), 0.1 mL THF in 1 mL 2 wt. % TPGS/H₂O were reacted at rt for 6 h yielding 174 mg (90%) of 3-isopropyl 5-(2-methoxyethyl) 4-(3-aminophenyl)-2,6-dimethylpyridine-3,5-dicarboxylate as a colorless oil (R_{f}=0.8, hexane/ethyl acetate: 90/10). HRMS(EI): Calcd. For C₂₁H₂₆N₂O₅ (M)⁺386.1842. Found: 386.1837.

### (4-Aminophenyl)(4-(3-(trifluoromethyl)phenyl)piperazin-1-yl)methanone (35) CAS #737451-56-0

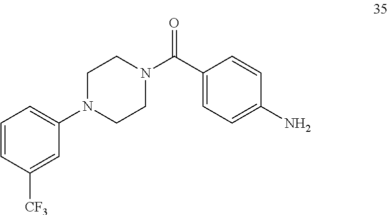 [SMILES: Nc1ccc(C(=O)N2CCN(c3cccc(C(F)(F)F)c3)CC2)cc1]

(4-Nitrophenyl)(4-(3-(trifluoromethyl)phenyl)piperazin-1-yl)methanone (190 mg, 0.5 mmol), Fe nano particles (6 mg), and NaBH₄ (28.5 mg, 0.75 mmol) in 0.5 mL 2 wt % TPGS/H₂O were reacted at rt for 18 h yielding 143 mg (82%) of (4-aminophenyl)(4-(3-(trifluoromethyl)phenyl)piperazin-1 -yl)methanone as a white semi-solid (R_{f}=0.2, hexane/ethyl acetate: 70/30). ¹⁹F NMR (376 MHz, DMSO) δ−61.3. HRMS (EI): Calcd. For C₁₈H₁₈F₃N₃O (M)⁺349.1402. Found: 349.1409.

### N-Benzyl-4-(trifluoromethyl)benzene-1,2-diamine(37) CAS#37814-05-4

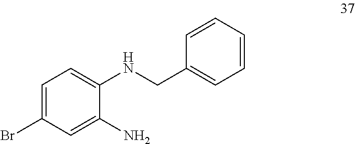 [SMILES: Nc1cc(Br)ccc1NCc1ccccc1]

N-benzyl-2-nitro-4-(trifluoromethyl)aniline (154 mg, 0.5 mmol), Fe nano particles (6 mg), and NaBH₄ (29 mg, 0.75 mmol) in 1 mL 2 wt. % TPGS/H₂O were reacted at rt for 4 h yielding 111 mg (80%) of N1-benzyl-4-(trifluoromethyl)benzene-1,2-diamine as a yellow oil (R_{f}=0.15, hexane/ethyl acetate: 70/30). Spectral data matched the literature. GC-MS, m/z: 266 [M⁺].

### 4,4′-(((5-Chloro-1,3-phenylene)bis(methylene))bis(oxy))dianiline (38)

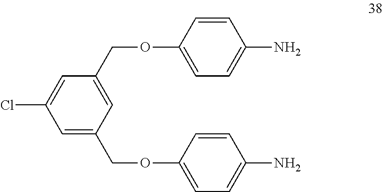 [SMILES: Nc1ccc(OCc2cc(Cl)cc(COc3ccc(N)cc3)c2)cc1]

4,4′-(((5-chloro-1,3-phenylene)bis(methylene))bis(oxy))bis(nitrobenzene) (207 mg, 0.5 mmol), Fe nano particles (10 mg), and NaBH₄ (45.6 mg, 1.2 mmol) in 1 mL 2 wt. % TPGS/H₂O were reacted at rt for 18 h yielding 136 mg (77%) of 4,4′-(((5-chloro-1,3-phenylene)bis(methylene))bis(oxy))dianiline as a yellow oil (hexane/ethyl acetate: 70/30). HRMS(EI): Calcd. For C₂₀H₁₉ClN₂O₂ (M)⁺354.1135. Found: 354.1138.

### Hex-3-yn-2-yl 4-aminobenzoate (39)

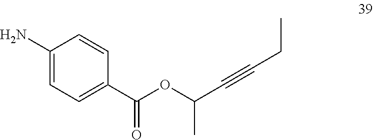 [SMILES: CCC#CC(C)OC(=O)c1ccc(N)cc1]

Hex-3-yn-2-yl 4-nitrobenzoate (124 mg, 0.5 mmol), Fe nano particles (12 mg), and NaBH₄ (46 mg, 1.2 mmol) in 1 mL 2 wt. % TPGS/H₂O were reacted at rt for 6 h yielding 99 mg (91%) of hex-3-yn-2-yl 4-aminobenzoate as a colorless oil (hexane/ethyl acetate: 80/20). HRMS(EI): Calcd. For C₁₃H₁₅NO₂ (M)⁺217.1103. Found: 217.1106.

### (3S,8S,9S,10R,13R,14S,17R)-10,13-dimethyl-17-((R)-6-methylheptan-2-yl)-2,3,4,7,8,9,10,11,12,13,14,15,16,17-tetradecahydro-1H-cyclopenta[a]phenanthren-3-yl 4-amino-2-methylbenzoate (40)

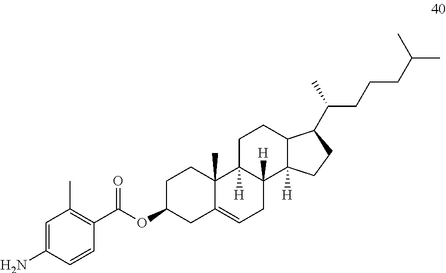

(3S,8S,9S,10R,13R,14S,17R)-10,13-dimethyl-17-((R)-6-methylheptan-2-yl)-2,3,4,7,8,9,10,11,12,13,14,15,16,17-tetradecahydro-1H-cyclopenta[a]phenanthren-3-yl 2-methyl-4-nitrobenzoate (250 mg, 0.5 mmol), Fe nano particles (10 mg), two drops THF and NaBH₄ (29 mg, 0.75 mmol) in 1 mL 2 wt. % TPGS/H₂O, 0.1 mL THF were reacted at rt for 16 h yielding 194 mg (75%) of (3S,8S,9S,10R,13R,14S,17R)-10,13-dimethyl-17-((R)-6-methylheptan-2-yl)-2,3,4,7,8,9,10,11,12,13,14,15,16,17-tetradecahydro-1H-cyclopenta[a]phenanthren-3-yl 4-amino-2-methyl benzoate as a white powder (R_{f}=0.8, hexane/ethyl acetate: 90/10). HRMS(ESI): Calcd. For C₃₅H₅₃NO₂Na (M+Na)⁺542.3974; Found: 542.3956.

### N-(Naphthalen-1-yl)-11-boranecarboxamide (41) CAS #72594-62-8

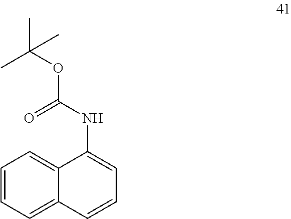 [SMILES: CC(C)(C)OC(=O)Nc1cccc2ccccc12]

1-Nitronaphthalene (86.5 mg, 0.5 mmol), Fe nano particles (6 mg), and NaBH₄ (21 mg, 0.6 mmol) in 1 mL 2 wt. % TPGS/H₂O were reacted at rt for 2 h, then Boc₂O (76 mg, 0.35mmol) was added. The mixture was stirred at rt for 8 h yielding 82 mg (90%) of N-(naphthalen-1-yl)-11-borane carboxamide as a colorless crystal (recrystallization from ethanol). Melting point: 90-92° C. ¹H NMR (500 MHz, DMSO) δ 9.21 (s, 1H), 8.05 (dd, J=5.5, 4.2 Hz, 1H), 7.92-7.86 (m, 1H), 7.70 (d, J=8.2 Hz, 1H), 7.57 (d, J=7.3 Hz, 1H), 7.53-7.47 (m, 2H), 7.47-7.42 (m, 1H), 1.49 (s, 9H). GC-MS, m/z: 322 [M⁺].

### (9H-Fluoren-9-yl)methyl (3-(trifluoromethyl)phenyl)carbamate (42)

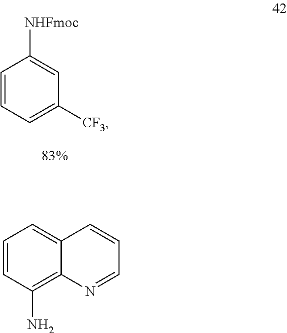

1-Nitro-3-(trifluoromethyl)benzene (95.5 mg, 0.5 mmol), Fe nano particles (6 mg), and NaBH₄ (20.9 mg, 0.6 mmol) in 1 mL 2 wt % TPGS/H₂O were reacted at rt for 2 h, then Fmoc-Cl (129 mg, 0.5mmol) was added. The mixture was stirred at rt for 4 h yielding 159 mg (83%) of (9H-fluoren-9-yl)methyl (3-(trifluoromethyl)phenyl)carbamate as a colorless oil. Spectral data matched the literature. HRMS(EI): Calcd. For C₂₂H₁₆F₃NO₂ (M)⁺383.1133. Found: 217.1136.

### 3-(((Allyloxy)carbonyl)amino)-5-nitrobenzoic acid (43)

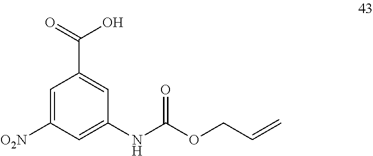 [SMILES: C=CCOC(=O)Nc1cc(C(=O)O)cc([N+](=O)[O-])c1]

3,5-Dinitrobenzoic acid (106 mg, 0.5 mmol), Fe nanoparticles (6 mg), and NaBH₄ (20.9 mg, 0.6 mmol) in 1 mL 2 wt. % TPGS/H₂O were reacted at rt for 2 h, then alloc-Cl (60 mg, 0.5 mmol) was added. The mixture was stirred at rt for 4 h yielding 109 mg (82%) of 3-(((allyloxy)carbonyl)amino)-5-nitrobenzoic acid as a colorless oil. ¹H NMR (500 MHz, Acetone) δ 8.71 (s, 1H), 8.51 (s, 1H), 8.40 (s, 1H), 6.03 (ddd, J=22.7, 10.8, 5.5 Hz, 1H), 5.41 (dd, J=17.2, 1.6 Hz, 1H), 5.25 (dd, J=10.5, 1.3 Hz, 1H), 4.69 (d, J=5.5 Hz, 2H); HRMS (ESI): Calcd. For C₁₁H₁₀N₂O₆Na (M+Na)⁺289.0437; Found: 289.0432.

### Imidodicarbonic acid, 2-(4-(4′-phenyl)-2-thiazolyl)-1,3-bis(1,1-dimethylethyl) ester (44)

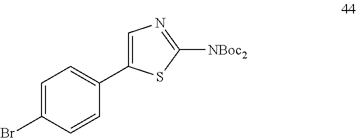

5-(4-Bromophenyl)-2-nitrothiazole (142 mg, 0.5 mmol), Fe nano particles (6 mg), and NaBH₄ (20.9 mg, 0.6 mmol) in 1 mL 2 wt. % TPGS/H₂O were reacted at rt for 2 h, then Boc₂O (109 mg, 0.5 mmol) was added. The mixture was stirred at rt for 12 h yielding 207 mg (91%) of N,N-BOC-amino-3-(4′-bromophenyl)thiazole as a white solid. Spectral data matched the literature. GC-MS, m/z: 383 [M⁺].

### Preparation of Fe-ppm Pd—Ni Nanoparticles:

In an oven dried round-bottomed flask, anhydrous 99.99% pure FeCl₃ (162 mg, 1 mmol), Pd(OAc)₂ (0.9 mg, 0.004mmol) and Ni(NO₃)₂.6H₂O (23.2 mg, 0.08 mmol) was added under an atmosphere of dry argon. The flask was covered with a septum, and 5 mL dry THF was added by syringe. The reaction mixture was stirred for 20 min at rt. While maintaining a dry atmosphere at RT, a 1 M solution of MeMgCl in THF was very slowly (1 drop/2 sec) added to the reaction mixture (about 1.2 mL, 1.2 mmol). After that addition, a 0.1 M solution of MeMgCl in THF was very slowly (1 drop/2 sec) added to the reaction mixture (0.7 mL, 0.07mmol). After complete addition of Grignard reagent, the mixture was stirred for an additional 20 min at rt. A yellow-brown color suggest the generation of nanomaterial.

After 20 min, the mixture was quenched with pentane (containing trace of water). THF was evaporated under reduced pressure at RT. Removal of THF was followed by triturating the mixture with pentane to provide yellow-brown colored nanomaterial as a powder (trituration was repeated 3-4 times). The Fe nanoparticles obtained were dried under reduced pressure at RT for 10 min yielding 0.6 g Fe-ppm Pd—Ni nanoparticles. The material was used for subsequent reactions under micelles conditions.

### General Procedure for Nitro Group Reduction:

Iron based nanomaterial (6 mg) was added to an oven dried 4 mL microwave reaction vial containing a PTFE-coated magnetic stir bar. After addition, 1 mL aqueous solution of 2 wt. % TPGS -750-M was added via syringe. The mixture was stirred at RT for 30 s. After stirring, 120 μL THF was added as co-solvent. After addition of co-solvent, NaBH₄ (57.0 mg, 1.50 mmol) was slowly added to the reaction mixture. (Caution-NaBH₄ should be added very slowly, especially for large scale reactions; i.e., >1 mmol). During addition of NaB H₄, the reaction mixture turned black with evolution of hydrogen gas. The nitro group-containing substrate was then added quickly to the catalyst suspension. The reaction vial was covered again with a rubber septum and stirred vigorously at RT. Progress of the reaction was monitored by TLC.

After complete consumption of starting material (by TLC), the septum was removed. Minimal amounts of an organic solvent (EtOAc, DCM, Et₂O etc.) were added, and the mixture was stirred for 1 min. Stirring was stopped and organic layer was then allowed to separate, after which it was removed via pipette. The same extraction procedure was repeated, and the combined organic extracts were dried over anhydrous Na₂SO₄. Volatiles were evaporated under reduced pressure and semi-pure product was purified by flash chromatography over silica gel. Caution: Never use acetone for TLC monitoring or column chromatography.

### Click Chemistry:

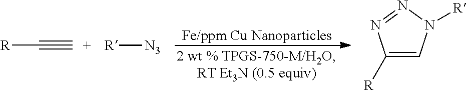

| Entry | Alkyne | Azide | Time | Isolated yield |
|---|---|---|---|---|
| 1 | 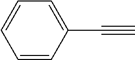 | 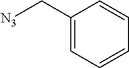 | 6 | 99 |
| 2 | 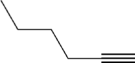 | 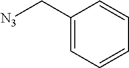 | 8 | 99 |
| 3 | 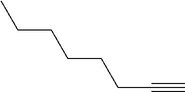 | 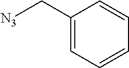 | 8 | 96 |
| 4 | 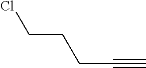 | 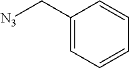 | 8 | 99 |
| 5 | 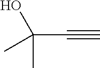 | 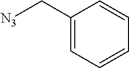 | 8 | 99 |
| 6 | 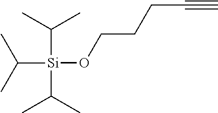 [SMILES: C#CCCCO[Si](C(C)C)(C(C)C)C(C)C] | 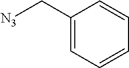 | 24 | 83 |
| 7 | 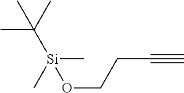 | 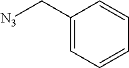 | 8 | 76 |
| 8 | 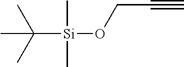 | 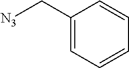 | 24 | 74 |
| 9 | 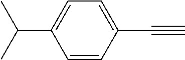 | 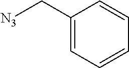 | 24 | 93 |
| 10 | 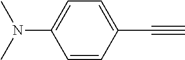 | 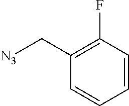 [SMILES: [N-]=[N+]=NCc1ccccc1F] | 8 | 99 |
| 11 | 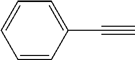 | 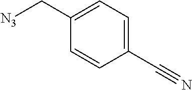 [SMILES: N#Cc1ccc(CN=[N+]=[N-])cc1] | 24 | 91 |
| 12 | 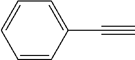 | 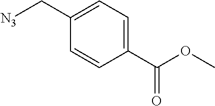 | 24 | 25 |
| 13 | 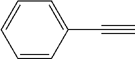 | 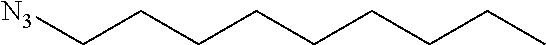 | 24 | 23 |
| 14 | 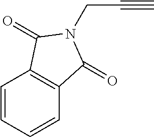 | 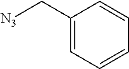 | 24 | 11 |
| 15 | 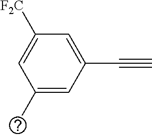 | 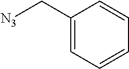 | 8 | 69 |
| 16 | 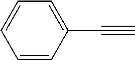 | 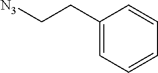 [SMILES: [N-]=[N+]=NCCc1ccccc1] | 8 | 91 |
| 17 | 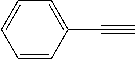 | 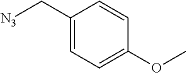 | 8 | 89 |

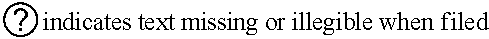

Synthesis of active nanoparticles: In a flame dried 2-N round-bottomed flask, anhydrous pure FeCl₃ (122 mg, 0.75 mmol) and CuOAc (1.84 mg, 0.015 mmol) were placed under dry argon. The flask was closed with a septum, and dry THF (10 mL) was added. The reaction mixture was stirred for 10 min at RT. While maintaining a dry atmosphere at room temperature, MeMgCl (2.25 ml, 1.125 mmol; 0.5 M solution) in THF was very slowly (1 drop/two sec) added to the reaction mixture. After complete addition of the Grignard reagent, the reaction mixture was stirred for an additional 30 min at RT. An appearance of a dark-brown coloration was indicative of generation of nanomaterial. THF was evaporated under reduced pressure at RT followed by triturating the mixture with dry pentane to provide a light brown-colored nanopowder. The nanomaterial was dried under reduced pressure at RT for 10 min and could be used as such for CuAAC reactions under micellar conditions.

### General Procedure for CuAAC (Cu Azide-Alkyne Cycloaddition) Reaction:

In a flame dried 10 mL microwave reaction vial, FeCl₃ (4.1 mg, 5 mol %) was added under anhydrous conditions. The reaction vial was closed with a rubber septum and the mixture was evacuated and backfilled with argon three times. Dry THF (0.7 mL) and CuOAc in THF (0.061 mL, 1000 ppm; 1 g/L) were added to the vial and the mixture was stirred for 10 min at RT, after which, MeMgCl in THF (0.75 mL, 7.5 mol %; 0.5 M) was added to the reaction mixture. While maintaining the inert atmosphere, THF was evaporated under reduced pressure. An aqueous solution of 2 wt % TPGS-750-M (1.0 mL) was added to the vial followed by sequential addition of alkyne (0.5 mmol), azide (0.6 mmol, 1.2 equiv), and triethylamine (0.0349 mL, 0.25 mmol, 0.5 equiv). The mixture was stirred vigorously at RT. After complete consumption of starting material, as monitored by TLC or GC-MS, EtOAc (1 mL) was added to the reaction mixture, which was stirred gently for 5 min. Stirring was stopped and the magnetic stir bar was removed. The organic layer was separated with the aid of a centrifuge and then dried over anhydrous magnesium sulfate. The solvent was then evacuated under reduced pressure to obtain crude material which was purified by flash chromatography over silica gel using EtOAc/hexanes as eluent. Spectral analysis show that the products obtained were consistent with the structure.

### Cross Coupling Reactions:

Transition metal-catalyzed cross-coupling reactions have become one of the most important transformations in organic chemistry. A. de Meijere, F. Diederich, Eds. Metal-Catalyzed Cross-Coupling Reactions, Vol. 2: Wiley-VCH, Weinheim, 2004. J.-P. Corbet, G. Mignani, Chem. Rev. 2006, 106, 2651. Development of efficient chiral or achiral ligands for metal-catalyzed cross-couplings has gained particular attention in the last twenty years. It has been demonstrated that the ligands play essential roles in the catalytic cycle, including oxidative addition, transmetallation, and reductive elimination. In addition, the steric and electronic properties of the ligand can greatly influence the rate, regioselectivity and stereoselectivity of the cross-coupling reactions. See, for example, S. L. Buchwald et al., J. Am. Chem. Soc. 2005, 127, 4685; S. L. Buchwald et al., Angew. Chem., Int. Ed. 2004, 43, 1871; S. L. Buchwald et al., J. Am. Chem. Soc. 2007, 129, 3358; S. L. Buchwald et al., WO2009/076622; J. F. Hartwig et al., WO 2002/011883; J. F. Hartwig et al., J. Am. Chem. Soc. 1996, 118, 7217; G. C. Fu et al., J. Am. Chem. Soc. 2001, 123, 10099; and Beller et al., Angew. Chem., Int. Ed. 2000, 39, 4153; M. Beller et al., Chem. Comm. 2004, 38. These researchers have developed efficient ligands for cross-coupling reactions forming carbon-carbon, carbon hydrogen, and carbon-heteroatom bond-forming reactions (“cross-coupling reactions”).

The Suzuki-Miyaura coupling reaction is one of most useful methods for the formation of carbon-carbon bonds and has been used in numerous synthetic processes. See N. Miyaura, Topics in Current Chem. 2002, 219, 11 and A. Suzuki, Organomet. Chem. 1999, 576, 147. Despite recent advances on this reaction, Suzuki-Miyaura couplings typically rely on catalyst loadings in the 1-5 mol % (10,000-50,000 ppm) range. Development of new ligands for cross coupling reactions, including Suzuki-Miyaura couplings, that enable both precious metal and non-precious metal catalysts to be used at the ppm level remains an important goal for synthetic chemistry; given the endangered metal status of several common transition metals (e.g., Pd), the need for a reduction in the environmental impact of such processes, the cost of precious metals, and the problems of removal of residual metals in targeted compounds, such as APIs (active pharmaceutical ingredients). Other common cross-couplings to which this invention applies, in particular, include Sonogashira couplings and amination reactions. Precious metal catalysis in organic synthesis, in large measure, has been and continues to be among the most heavily utilized inroads to C—C, C—H and C-heteroatom bond constructions. Chief among these lies palladium chemistry, and with the 2010 Nobel Prizes recognizing Pd-catalyzed Suzuki, Heck and Negishi couplings, even greater use of these and related processes are to be expected.

In one embodiment, there is provided a catalyst composition comprising: a) a reaction solvent or a reaction medium; b) organometallic nanoparticles as described herein. In one variation, the organometallic nanoparticles comprises: i) a nanoparticle (NP) catalyst, prepared by a reduction of an iron salt in an organic solvent, wherein the catalyst comprises at least one other metal selected from the group consisting of Pd, Pt, Au, Ni, Co, Cu, Mn, Rh, Ir, Ru and Os or mixtures thereof; c) a ligand, for example, of the formula A:

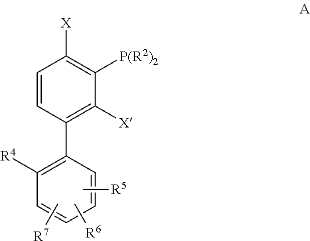

wherein the variables are as defined herein; and d) a transition metal or mixtures of two or more transition metals present in less than or equal to 50,000 ppm relative to the iron salt; or relative to the substrate. As disclosed herein, the coupling reactions may employ any phosphine ligand as known in the art, including mono- or bi-dentate, with the preferred ligands being SPhos for the Suzuki couplings, and XPhos for the Sonogashira couplings or one or more ligands of the formula A. In addition, co-solvents may be employed for any of these Pd catalyzed couplings.

In another embodiment, the application discloses the use of composites or compositions comprising nanoparticles (NPs) as disclosed herein. In another aspect, the NPs are as isolable powders derived from an iron (Fe) metal, such as an Fe(II) salt or an Fe(III) salt. In one aspect, the NPs contain C, H, O, Mg, halogen and Fe in their matrix. In another aspect, these NPs may also contain ppm levels of other metals, especially transition metals (e.g., Pd, Pt, Au, Ni, Co, Cu, Mn, Rh, Ir, Ru and Os, and mixtures thereof), that may be either present in the Fe(II) or Fe(III) salts or the transition metals may be added externally prior to reduction (e.g., using Pd(OAc)₂, etc.). In one variation, the transition metal is Pd, Pt or Ni, or a mixture thereof. In the resulting composite, these NPs may be used as heterogeneous catalysts, in an aqueous micellar medium. In another aspect, the NPs may be used to mediate transition metal-catalyzed reactions. Such metal-catalyzed reactions may include reactions that are catalyzed by Pd (e.g., Suzuki-Miyaura and Sonogashira couplings, etc.), as well as reductions of selected functional groups (e.g., aryl/heteroaryl nitro groups).

In one variation of the above catalyst composition, the metal or mixtures thereof is present in less than or equal to 40,000 ppm, 30,000 ppm, 20,000 ppm, 10,000 ppm, 5,000 ppm, 3,000 ppm, 2,000 ppm or 1,000 ppm. In another variation, the metal or mixtures thereof is present in less than or equal to 1,000 ppm. In another variation of the composition, the presence of a surfactant provides nanoparticles or nanomicelles for housing a substrate. In another variation, the composition may be used in reactions employing standard organic solvents, organic solvents or solvent mixtures and/or organic solvents in polar media or another polar solvent, such as in water. In another variation, the polar solvent or polar reaction medium is water. In yet another variation, the polar solvent or polar reaction medium is a glycol or glycol ether selected from ethyleneglycol, propylene glycol, 2-methoxyethanol, 2-ethoxyethanol, 2-propoxyethanol, 2-isopropoxyethanol, 2-butoxyethanol, 2-phenoxyethanol, 2-benzyloxyethanol, 2-(2-methoxyethoxy)ethanol, 2-(2-ethoxyethoxy)ethanol, 2-(2-butoxyethoxy)ethanol, dimethoxyethane, diethoxyethane and dibutoxyethane; or mixtures thereof. In one variation of the above, the organometallic nanoparticles are present as a complex. In another variation, the reaction medium is a micellar medium or an aqueous micellar medium. In another variation, the catalyst composition further comprises water.

In one embodiment, the application discloses a ligand of the formula A:

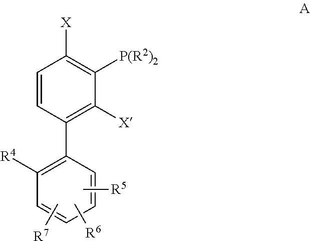

wherein:

X is selected from —OR¹ or —NR′R″ where R′ and R″ is independently selected from the group consisting of H, C₁₋₁₀alkyl, C₃₋₆cycloalkyl, C₆₋₁₄aryl and C₄₋₁₂heteroaryl;

X′ is selected from —OR³ or —NR′R″ where R′ and R″ is independently selected from the group consisting of H, C₁₋₁₀alkyl, C₃₋₆cycloalkyl, C₆₋₁₄aryl and C₄₋₁₂heteroaryl;

each R¹ and R³ is independently selected from a group consisting of C₁₋₁₀alkyl, C₃₋₆cycloalkyl, C₆₋₁₄aryl and C₄₋₁₂heteroaryl;

R² is selected from the group consisting of C₁₋₁₀alkyl, C₃₋₆cycloalkyl, C₆₋₁₄aryl and substituted C₆₋₁₄aryl and C₄₋₁₂heteroaryl;

R⁴ is H or is selected from the group consisting of —OC₁₋₁₀alkyl, C₁₋₁₀alkyl, C₃₋₆cycloalkyl, —SR⁸, —NR⁸R⁹, C₆₋₁₄aryl and C₄₋₁₂heteroaryl;

each R⁵ and R⁶ is H or R⁵ and R⁶ together with the aryl group to which they are attached to form a fused substituted or unsubstituted aromatic ring or heteroaromatic ring;

R⁷ is H or is selected from the group consisting of —OC₁₋₁₀alkyl and C₁₋₁₀alkyl, —SR⁸, —NR⁸R⁹, C₆₋₁₄aryl and C₄₋₁₂heteroaryl; and each R⁸ and R⁹ is independently H or C₁₋₁₀alkyl.

In one variation of the ligand, each R¹ and R³ is independently selected from a group consisting of —CH₃, —CH₂CH₃, CH₂CH₂CH₃, —CH₂CH₂CH₂CH₃, -phenyl, 1-naphthyl and 2-naphthyl. In another variation, R⁴ is a substituted or unsubstituted C₆₋₁₄aryl or a substituted or unsubstituted C₄₋₁₂heteroaryl. In another variation, R⁴ is selected from the group consisting of —OC₁₋₃alkyl, —OC₁₋₆alkyl and C₁₋₃alkyl. In another variation, R⁴ is selected from the group consisting of —OCH₃, —OCH₂CH₃, —CH₃, —CH₂CH₃, —CH₂CH₂CH₃ and —CH₂CH₂CH₂CH₃.

In another variation, each R² is independently selected from the group consisting of cyclopentyl, cyclohexyl, t-butyl, substituted or unsubstituted C₆₋₁₄aryl or a substituted or unsubstituted C₄₋₁₂heteroaryl. In one variation of the above, the aryl or heteroaryl ring is substituted by 1 or 2 substituents independently selected from the group consisting of nitro, CF₃—, CF₃O—, CH₃O—, —COOH, —NH₂, —OH, —SH, —NHCH₃, —N(CH₃)₂, —SMe and —CN.

In one aspect, the ligand is of the formula A-1:

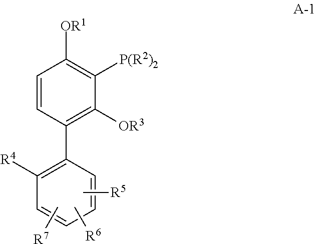

wherein: each R¹ and R³ is independently selected from a group consisting of C₁₋₁₀alkyl, C₃₋₆cycloalkyl, C₆₋₁₄aryl and C₄₋₁₂heteroaryl;

R² is selected from the group consisting of C₁₋₁₀alkyl, C₃₋₆cycloalkyl, C₆₋₁₄aryl and substituted C₆₋₁₄aryl and C₄₋₁₂heteroaryl

R⁴ is H or is selected from —OC₁₋₁₀alkyl and C₃₋₆cycloalkyl;

each R⁵ and R⁶ is H or R⁵ and R⁶ are each independently an aryl or a heteroaryl ring, or R⁵ and R⁶ together with the aryl group to which they are attached to form a substituted or unsubstituted aromatic ring; and R⁷ is H or is selected from the group consisting of —OC₁₋₁₀alkyl, C₁₋₁₀oalkyl, —SR⁸, —NR⁸R⁹, C₆₋₁₄aryl and C₄₋₁₂heteroaryl.

In another aspect of the ligand, R⁵ and R⁶ together form a substituted or unsubstituted aromatic ring or a substituted or unsubstituted heteroaromatic ring. In one variation of the above, the aromatic ring is a phenyl ring or a naphthyl ring, and the heteroaromatic ring is selected from the group consisting of furan, imidazole, oxazole, pyrazine, pyrazole, pyridazine, pyridine and pyrimidine.

In another aspect of the above, the ligand is of the formula B or C:

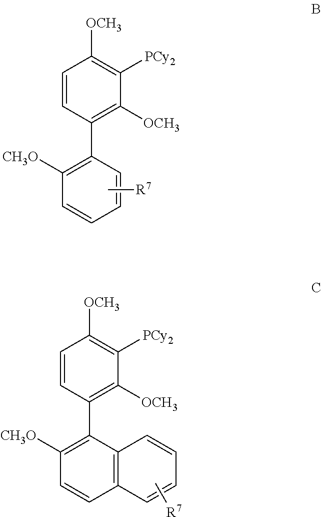

wherein: R⁷ is H or is selected from the group consisting of —OC₁₋₁₀alkyl, C₁₋₁₀alkyl, —SR⁸, —NR⁸R⁹, C₆₋₁₄aryl and C₄₋₁₂heteroaryl.

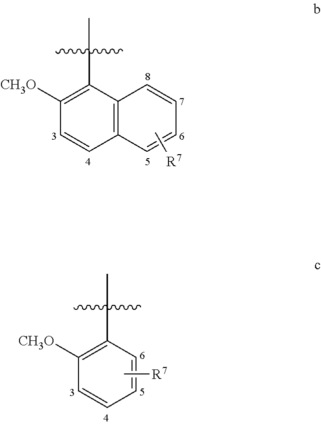

As represented herein, an aryl group such as in b or c showing a substituent position of R⁷ means that for b, R⁷ may be substituted at any of the open position of the phenyl group, such as the 3-phenyl, 4-phenyl, 5-phenyl or 6-phenyl; and for c, R⁷ may be substituted at any of the open position of the phenyl group, such as the 3-naphthyl, 4-napthyl, 5-naphthyl, 6-naphthyl, 7-naphthyl or 8-naphthyl. In certain variations, R⁷ may be substituted in one or independently on both aryl ring of the naphthyl ring.

In another aspect of the compound of formula A, the compound comprises the formulae B-1, B-2 and B-3:

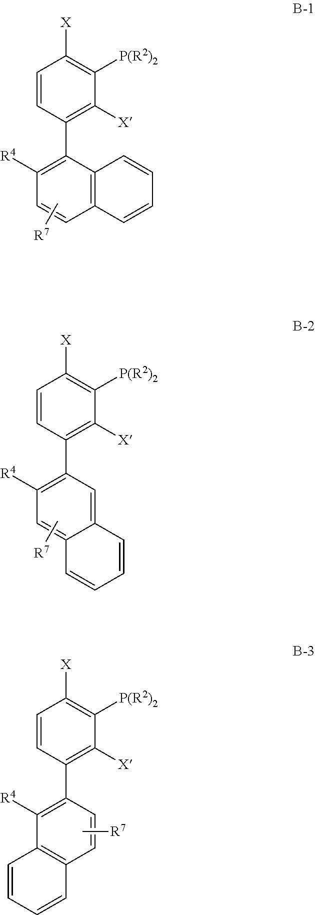

In another aspect of the above composition, the iron is selected from the group consisting of a Fe(II) or Fe(III) salt, a Fe(II) salt precursor or Fe(III) salt precursor. In another aspect, the palladium is naturally present in the iron salt in amounts less than or equal to 1 ppm, 10 ppm, 50 ppm, 100 ppm, 200 ppm, 300 ppm, 400 ppm or 500 ppm relative to the iron salt or iron complex. As used herein, the term “naturally present” means that the palladium is present in the iron salt as obtained from commercial or natural sources and additional palladium is not added to the iron salt. In another aspect, the amount of Pd present is controlled by external addition of a Pd salt to an iron salt.

In another embodiment, there is provided a method for performing a cross coupling reaction between a first coupling substrate of the formula I with a second coupling substrate of the formula II in a reaction condition sufficient to form the coupled product of the formula III:

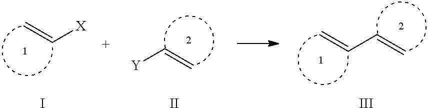

wherein:

X is selected from the group consisting of Cl, Br and I and pseudo halides;

Y is selected from the group consisting of B(OH)₂, B(OR)₂, cyclic boronates, acyclic boronates, B(MIDA), Bpin, BR(OR) and BF₃K, where R is selected from methyl, ethyl, propyl, butyl, isopropyl, ethylene glycol, trimethylene glycol, a cyclic array attaching R to —OR and pinacol;

each of the groups

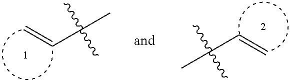

is independently selected from the group consisting of an alkene or a substituted alkene, a cycloalkene or a substituted cycloalkene, an alkyne or a substituted alkyne, an aryl or a substituted aryl, and a heteroaryl or a substituted heteroaryl;

the method comprising:

i) forming a nanoparticles composition in which the partners I and II are solubilized in water, and an organometallic complex comprising nanoparticles, such as iron nanoparticles, wherein another metal is present in less than 50,000 ppm relative to the limiting substrate of the formula I or formula II, and wherein the composition further comprises a ligand of the formula A:

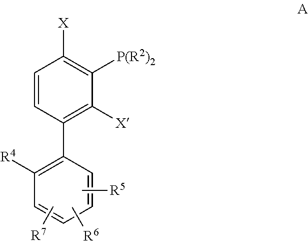

wherein:

X is selected from —OR¹ or —NR′R″ where R′ and R″ is independently selected from the group consisting of H, C₁₋₁₀alkyl, C₃₋₆cycloalkyl, C₆₋₁₄aryl and C₄₋₁₂heteroaryl;

X′ is selected from —OR³ or —NR′R″ where R′ and R″ is independently selected from the group consisting of H, C₁₋₁₀alkyl, C₃₋₆cycloalkyl, C₆₋₁₄aryl and C₄₋₁₂heteroaryl;

each R¹ and R³ is independently selected from a group consisting of C₁₋₁₀alkyl, C₃₋₆cycloalkyl, C₆₋₁₄aryl and C₄₋₁₂heteroaryl;

R² is selected from the group consisting of C₁₋₁₀alkyl, C₃₋₆cycloalkyl, C₆₋₁₄aryl, and substituted C₆₋₁₄aryl and C₄₋₁₂heteroaryl;

R⁴ is H or is selected from the group consisting of —OC₁₋₁₀alkyl, C₁₋₁₀alkyl, C₃₋₆cycloalkyl, —SR⁸, —NR⁸R⁹, C₆₋₁₄aryl and C₄₋₁₂heteroaryl;

each R⁵ and R⁶ is H or R⁵ and R⁶ together with the aryl group to which they are attached to form a substituted or unsubstituted aromatic ring or heteroaromatic ring;

R⁷ is H or is selected from the group consisting of —OC₁₋₁₀alkyl and C₁₋₁₀alkyl, —SR⁸, —NR⁸R⁹, C₆₋₁₄aryl and C₄₋₁₂heteroaryl; and each R⁸ and R⁹ is independently H or C₁₋₁₀alkyl; and ii) contacting the first coupling substrate with the second coupling substrate in water under a condition sufficient to form a product mixture comprising a cross coupling product of the formula III. In one aspect of the method, the metal, other than Pd, is selected from the group consisting of Pt, Au, Ni, Co, Cu, Mn, Rh, Ir, Ru and Os or a mixture thereof.

In another aspect of the above method, the reaction condition comprises an organic solvent or a mixture of organic solvents or either of these reaction media containing varying percentages of water under a condition sufficient to form a product mixture comprising a cross coupling product of the formula III. In yet another aspect of the method, the reaction condition comprises water and a surfactant, and further comprising an organic solvent as co-solvent. In another aspect of the method, the organic solvent is selected from the group consisting of methanol, ethanol, propanol, isopropanol, butanol(s), n-butanol, 2-butanol, cyclohexane, heptane(s), hexanes, pentanes, isooctane, toluene, xylenes, acetone, amyl acetate, isopropyl acetate, ethyl acetate, methyl acetate, n-butylacetate, methyl formate, diethyl ether, cyclopropyl methyl ether, THF, 2-methyl-THF, acetonitrile, formic acid, acetic acid, ethyleneglycol or PEGs/MPEGs wherein the PEG has a molecular weight range from 300 g/mol to 10,000,000 g/mol, trifluoromethylbenzene, triethylamine, dioxane, sulfolane, MIBK, MEK, MTBE, DMSO, DMF, DMA, NMP and mixtures thereof.

In one variation of the catalyst composition and the method disclosed in the present application, the reaction solvent is water. In another variation, the reaction solvent is a mixture of water and an organic solvent or co-solvent. In one variation, the composition comprises water in an amount of at least 1% wt/wt (weight/weight) of the mixtures. In another embodiment, the water in the mixture is present in an amount of at least 5%, at least 10%, at least 50%, at least 75%, at least 90% or at least 99% wt/wt or more of the mixture. In another variation, the organic co-solvent in the reaction solvent is present in at least 5%, 7%, 10%, 15%, 20%, 30%, 40%, 50%, 70%, 80% or 90% with the remaining being water or a polar solvent. In yet another variation, the organic co-solvent is present at a wt of organic co-solvent to the wt of water (wt/wt) of 1/10, 2/10, 3/10, 5/10, 7/10, 9/10, 10/10, 12/10, 15/10, 17/10, 20/10, 25/10, 30/10, 35/10, 50/10, 60/10, 70/10, 80/10, 90/10, 100/10, 150/10, 200/10, 250/10, 300/10, 400/10, 500/10, 600/10, 700/10, 800/10, 900/10, 1,000/10, 5,000/10 and 10,000/10. In one variation, the reaction may be performed in one of the above reaction solvent composition by wt/wt (e.g., 1/10, organic solvent to water), as a first solvent composition, and when the reaction is completed, the reaction solvent composition may be changed to another composition or second wt/wt composition (e.g., 150/10), to facilitate at least one of the processing of the reaction mixture; transferring of reaction mixture, isolating components of the reaction mixture including the product, minimizing the formation of emulsions or oiling out of the reactants and/or products, and providing an increase in the reaction yields; or a combination thereof. Depending on the reaction or processing steps, the reaction mixture may be changed to a third or other, subsequent solvent composition. In another aspect, water is the only reaction medium in the mixture. In another aspect, non-exclusive examples of the organic solvent or co-solvent may include C₁-C₆ alcohols such as methanol, ethanol, propanol, isopropanol, butanol(s), n-butanol, 2-butanol, etc . . . , hydrocarbons such as cyclohexane, heptane(s), hexanes, pentanes, isooctane, and toluene or xylenes, or acetone, amyl acetate, isopropyl acetate, ethyl acetate, n-butyl acetate, methyl acetate, methyl formate, diethyl ether, cyclopropyl methyl ether, THF, 2-methyl-THF, acetonitrile, formic acid, acetic acid, ethyleneglycol or PEGs/MPEGs of any length of ethylenoxy units, trifluoromethylbenzene, triethylamine, dioxane, sulfolane, MIBK, MEK, MTBE, DMSO, DMF, DMA, NMP or mixtures thereof.

### Synthesis of Active Nanoparticles:

In a flame dried two-neck round-bottomed flask, anhydrous pure FeCl₃ (500 mg, 3.09 mmol), XPhos (1180 mg, 2.47 mmol), and Pd(OAc)₂ (6.0 mg, 0.027 mmol) were placed under an atmosphere of dry argon. The flask was closed with a septum, and dry THF (10 mL) was added. The reaction mixture was stirred for 20 min at RT. While maintaining a dry atmosphere at RT, MeMgCl (12.4 ml, 6.18 mmol; 0.5 M solution) in THF was very slowly (1 drop/two sec) added to the reaction mixture. After complete addition of the Grignard reagent, the reaction mixture was stirred for an additional 10 min at RT. An appearance of a dark-brown coloration was indicative of generation of nanomaterial. After 20 min, the mixture was quenched with a 0.1 mL of degassed water, and THF was evaporated under reduced pressure at RT followed by triturating the mixture with dry pentane to provide a light brown-colored nanopowder (2.82 g, including material bound to THF). The nanomaterial was dried under reduced pressure at RT for 10 min and could be used as such for Sonogashira reactions under micellar conditions.

### General Procedure for Sonogashira Reactions:

### a) Using In Situ Formation of Catalyst:

Fe/ppm Pd nanoparticle formation as well as Sonogashira reactions were air sensitive, all reactions were ran under argon. Pure FeCl₃ (97%, source Sigma-Aldrich) was doped with 320 ppm of palladium using 0.005 M solution of Pd(OAc)₂ (Oakwood Chemicals) in dry CH₂Cl₂ when nanoparticles were in situ formed.

In a flame dried 4 mL microwave reaction vial, FeCl₃ (4.1 mg, 5 mol %) containing ppm levels of palladium (ca. 350 ppm), XPhos (12 mg, 5 mol %) was added under anhydrous conditions. The reaction vial was closed with a rubber septum and the mixture was evacuated-and-backfilled with argon three times. Dry CH₂Cl₂ (1.0 mL) was added to the vial and the mixture was stirred for 30 min at RT, after which, while maintaining the inert atmosphere, CH₂Cl₂ was evaporated under reduced pressure. MeMgCl in THF (0.2 mL, 10 mol %; 0.1 M) was added to the reaction mixture, which was stirred at RT for 1 min. A freshly degased aqueous solution of 2 wt % TPGS-750-M (1.0 mL) was added to the vial followed by sequential addition of aryl bromide or iodide (0.5 mmol), terminal alkyne (0.75 mmol, 1.5 equiv) and triethylamine (139 μL, 1.0 mmol, 2.0 equiv). The vial was closed with a rubber septum and evacuated-and-back-filled with argon three times. The mixture was stirred vigorously at 45° C. for the desired time period.

After complete consumption of starting material, by TLC or GCMS, the reaction mixture was allowed to cool to RT. EtOAc or MTBE (1 mL) or 5% EtOAc/MTBE was added to the reaction mixture, and stirred gently for 5 min. Stirring was stopped and the magnetic stir bar was removed. The organic layer was separated with the aid of a centrifuge and then dried over anhydrous sodium sulfate. The solvent was then evacuated under reduced pressure to obtain crude material which was purified by flash chromatography over silica gel using EtOAc/hexanes or ether/hexanes as eluent.

### a) Using Isolated Catalyst:

Under the argon atmosphere, 30 mg nanoparticles were added in to a flame dried 4 mL reaction vial. Reaction vial was closed with a rubber septum and 1.0 mL freshly degassed aqueous solution of 2 wt % TPGS-750-M was added to it via syringe. Reaction mixture was stirred for a minute at RT followed by sequential addition of aryl bromide or iodide (0.5 mmol), terminal alkyne (0.75 mmol, 1.5 equiv) and triethylamine (139 μL, 1.0 mmol, 2.0 equiv). The vial was closed with a rubber septum and evacuated-and-back-filled with argon three times. The mixture was stirred vigorously at 45° C. for the desired time period. After complete consumption of starting material, as monitored by TLC or GCMS, the reaction mixture was allowed to cool to RT. EtOAc or MTBE (1 mL) or 5% EtOAc/MTBE was added to the reaction mixture, which was stirred gently for 5 min. Stirring was stopped and the magnetic stir bar was removed. The organic layer was separated with the aid of a centrifuge and then dried over anhydrous sodium sulfate. The solvent was then evacuated under reduced pressure to obtain crude material which was purified by flash chromatography over silica gel using EtOAc/hexanes or ether/hexanes as eluent.

TABLE S1
Noted Changes from the standard conditions:

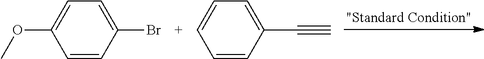

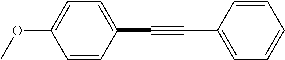

“Standard Condition”: 4-Bromoanisole (0.5 mmol, 1.0 equiv), phenylacetylene (0.75 mmol,
1.5 equiv.), XPhos (3 mol %), FeCl₃ (5 mol %), Pd(OAc)₂ (500 ppm), Et₃N (1 mmol, 2.0 equiv.),
TPGS-750-M (2 wt %, 0.5M), Ar, 24 h.

| Entry | Changes from “standard conditions” | Yield (%)^{a} |
|---|---|---|
| 1 | — | 95 |

Ligand changes

| | | |
|---|---|---|
| 2 | no ligand | <1 |
| 3 | PPh₃ | 22 |
| 4 | SPhos | 90 |
| 5 | tBuBrettPhos | 47 |
| 6 | XPhos (5 mol %) | 95 |
| 7 | XPhos (1 mol %) | 83 |

Base changes

| | | |
|---|---|---|
| 8 | K₃PO₄•H₂O | 74 |
| 9 | K₂CO₃ | 62 |
| 10 | Cs₂CO₃ | 65 |
| 11 | KOAc | 46 |
| 12 | DIPEA | 94 |

Other changes

| | | |
|---|---|---|
| 13 | no Pd(OAc)₂ | <1 |
| 14 | Pd(OAc)₂ (320 ppm) | 87 |
| 15 | PdCl₂ (500 ppm) | 31 |
| 16 | Cu(OAc)₂ (500 Ppm) | <1 |
| 17 | Ni(oAc)₂ (500 Ppm) | <1 |
| 18 | no FeCl₃ | <1 |

^{a}Yields based on GC-MS.

Reaction conditions: In a flame dry 4 ml microwave reaction vial, pure FeCl₃ (4.1 mg, 5 mol %) and ligand (1-5 mol %) was added under anhydrous conditions. Reaction vial was closed with rubber septum, and mixture was evacuated and backfilled with argon. 1.0 ml dry THF was added to the vial and different metal salts (0-500 ppm) was added using their 5 mM solution in dry THF. The mixture was stirred for 30 minutes at RT. After 30 minutes, dissolution and complexation of iron chloride was clearly visualized by color change. While under inert atmosphere, THF was evaporated under reduced pressure at RT. 0.2 M MeMgBr (0.25 ml, 10 mol %) was added to the reaction mixture, and mixture was stirred at RT for a minute. 1 ml aqueous solution 2 wt % TPGS-750-M was added to the vial followed by sequential addition of 4-bromoanisole (93.5 mg, 0.5 mmol, 1.0 equiv.), phenylacetylene(76.5 mg, 0.75 mmol, 1.5 equiv.), and base (1 mmol, 2 equiv.). Reaction vial was closed with septum under argon atmosphere. Reaction mixture was stirred at 45° C. for 24 h. After 24 h, reaction mixture was cooled to RT. 1.0 ml EtOAc was added to the reaction mixture, and mixture stirred for 5 minutes at RT. Stirring was stopped and organic layer was decanted with pipette. Organic layer was passed through a very small silica plug. Yields were determined by GC-MS using mesitylene as internal standard.

### Representative Procedure for Use of Fe/ppm Pd NPs in Suzuki-Miyaura Cross-Couplings:

In a flame dried 4 mL microwave reaction vial containing a PTFE coated magnetic stir bar, nanomaterial 20 mg), aryl bromide (0.5 mmol), arylboronic acid (0.6 mmol, 1.2 equiv), and tribasic potassium phosphate monohydrate (173 mg, 0.75 mmol, 1.5 equiv) were added under an atmosphere of argon. The reaction vial was closed with a rubber septum, and mixture was stirred vigorously at 45° C. for 14-24 h.

After complete consumption of starting material, as monitored by TLC, the reaction mixture was allowed to cool to RT. EtOAc (1 mL) was added and the mixture stirred gently for 5 min. Stirring was stopped and the magnetic stir bar was removed from the mixture. The organic layer was separated with the aid of a centrifuge, and then dried over anhydrous sodium sulfate. The solvent was evacuated under reduced pressure to obtain crude material as a viscous oil. The product was purified by flash chromatography over silica gel using EtOAc/hexanes as eluent.

### General Procedure for Sonogashira Reactions:

In a flame dry 4 ml microwave reaction vial, pure FeCl₃ (4.1 mg, 5 mol %) and XPhos (7.1 mg, 3 mol %) was added under anhydrous conditions. Reaction vial was closed with rubber septum, and mixture was evacuated and backfilled with argon. 1.0 ml dry THF was added to the vial and Pd(OAc)₂ (500 ppm) was added using 5 mM solution of Pd(OAc)₂ in dry THF.Then the mixture was stirred for 30 minutes at RT. After 30 minutes, dissolution and complexation of iron chloride was clearly visualized by color change. While under the inert atmosphere, THF was evaporated under reduced pressure at RT. 0.2 M MeMgBr (0.25 ml, 10 mol %) was added to the reaction mixture, and mixture was stirred at RT for a minute. 1 ml aqueous solution 2 wt% TPGS-750-M was added to the vial followed by sequential addition of aryl halide (0.5 mmol, 1.0 equiv.), alkyne (0.75 mmol, 1.5 equiv.), and Et₃N (101 mg, 1 mmol, 2 equiv.). Reaction vial was closed with septum under argon atmosphere. Reaction mixture was stirred at 45° C. for 12-48 h. Reaction mixture was cooled to RT. Following, the mixture was extracted with EtOAc (0.2 mL×3) with the help of centrifuge to phase separation. The combined organic extracts were dried over anh. Na₂SO₄. Volatiles were removed under reduced pressure to obtain crude product which were further purified by flash chromatography over silica gel using EtOAc/hexanes as eluent.

### Diphenylacetylene CAS: 501-65-5

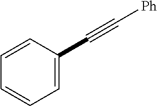

Yield 84.2 mg (95%) of diphenylacetylene as a colorless solid (hexane/ethyl acetate: 95/5). Spectral data matched to literature. ¹H NMR (500 MHz, CDCl₃) δ 7.08 (d, J=8.4 Hz, 2H), 6.58 (d, J=8.8 Hz, 2 H), 3.63 (s, br, 2H); GC-MS, m/z: 178 [M⁺].

### 1-methoxy-4-(phenylethynyl)benzene CAS: 7380-78-1

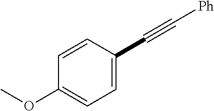

Yield 84.2 mg (95%) of 1-methoxy-4-(phenylethynyl)benzene as a colorless solid (hexane/ethyl acetate: 90/10). Spectral data matched to literature. ¹H NMR (500 MHz, CDCl₃) δ 7.08 (d, J=8.4 Hz, 2H), 6.58 (d, J=8.8 Hz, 2H), 3.63 (s, br, 2H); GC-MS, m/z: 178 [M⁺].

### 1-methylthio-4-(phenylethynyl)benzene CAS: 33533-42-5

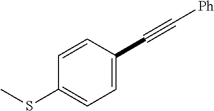

Yield 84.2 mg (95%) of 1-methylthio-4-(phenylethynyl)benzene as a colorless solid (hexane/ethyl acetate: 90/10). Spectral data matched to literature. ¹H NMR (500 MHz, CDCl₃) δ 7.08 (d, J=8.4 Hz, 2 H), 6.58 (d, J=8.8 Hz, 2H), 3.63 (s, br, 2H); GC-MS, m/z: 178 [M⁺].

### 4-(phenylethynyl)phenol CAS: 1849-26-9

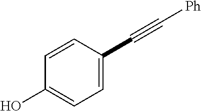

Yield 84.2 mg (95%) of 4-(phenylethynyl)phenol as a colorless solid (hexane/ethyl acetate: 95/5). Spectral data matched to literature. ¹H NMR (500 MHz, CDCl₃) δ 7.08 (d, J=8.4 Hz, 2H), 6.58 (d, J=8.8 Hz, 2H), 3.63 (s, br, 2H); GC-MS, m/z: 178 [M⁺].

### 2-(phenylethynyl)aniline CAS: 13141-38-3

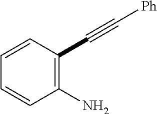

Yield 84.2 mg (95%) of 2-(phenylethynyl)aniline as a colorless solid (hexane/ethyl acetate: 95/5). Spectral data matched to literature. ¹H NMR (500 MHz, CDCl₃) δ 7.08 (d, J=8.4 Hz, 2H), 6.58 (d, J=8.8 Hz, 2H), 3.63 (s, br, 2H); GC-MS, m/z: 178 [M⁺].

### Methyl (2-(phenylethynyl)phenyl)carbamate CAS: 116525-60-1

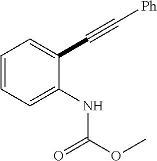

Yield 84.2 mg (95%) of methyl (2-(phenylethynyl)phenyl)carbamate as a colorless solid (hexane/ethyl acetate: 95/5). Spectral data matched to literature. ¹H NMR (500 MHz, CDCl₃) δ 7.08 (d, J=8.4 Hz, 2H), 6.58 (d, J=8.8 Hz, 2 H), 3.63 (s, br, 2H); GC-MS, m/z: 178 [M⁺].

### 6-(4-methoxyphenyl)hex-5-yn-1-ol CAS: 128599-33-7

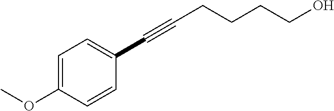

Yield 84.2 mg (95%) of 6-(4-methoxyphenyl)hex-5-yn-1-ol as a colorless solid (hexane/ethyl acetate: 95/5). Spectral data matched to literature. ¹H NMR (500 MHz, CDCl₃) δ 7.08 (d, J=8.4 Hz, 2H), 6.58 (d, J=8.8 Hz, 2H), 3.63 (s, br, 2H); GC-MS, m/z: 178 [M⁺].

### 6-(2-fluoro-5-nitrophenyl)hex-5-yn-1-yl 3-methyl-4-nitrobenzoate

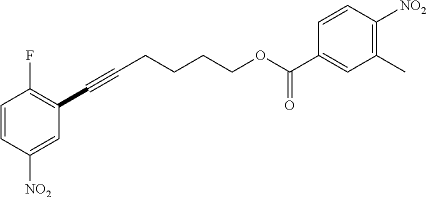

Yield 84.2 mg (95%) of 6-(2-fluoro-5-nitrophenyl)hex-5-yn-1-yl 3-methyl-4-nitrobenzoate as a colorless solid (hexane/ethyl acetate: 80/20). ¹H NMR (500 MHz, CDCl₃) δ 7.08 (d, J=8.4 Hz, 2H), 6.58 (d, J=8.8 Hz, 2H), 3.63 (s, br, 2 H); GC-MS, m/z: 178 [M⁺].

### 6-(4-methoxyphenyl)hex-5-yn-1-yl 3 -methyl-4-nitrobenzoate

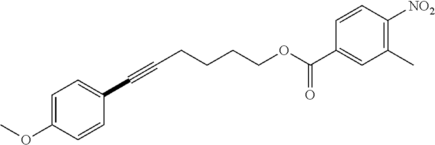

Yield 84.2 mg (95%) of 6-(4-methoxyphenyl)hex-5-yn-1-yl 3-methyl-4-nitrobenzoate as a colorless solid (hexane/ethyl acetate: 80/20). ¹H NMR (500 MHz, CDCl₃) δ 7.08 (d, J=8.4 Hz, 2H), 6.58 (d, J=8.8 Hz, 2H), 3.63 (s, br, 2H); GC-MS, m/z: 178 [M⁺].

### 6-(6-methylpyridin-2-yl)hex-5-yn-1-yl 3-methyl-4-nitrobenzoate

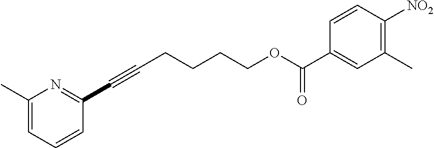

Yield 84.2 mg (95%) of 6-(6-methylpyridin-2-yl)hex-5-yn-1-yl 3-methyl-4-nitrobenzoate as a colorless solid (hexane/ethyl acetate: 80/20). ¹H NMR (500 MHz, CDCl₃) δ 7.08 (d, J=8.4 Hz, 2H), 6.58 (d, J=8.8 Hz, 2H), 3.63 (s, br, 2H); GC-MS, m/z: 178 [M⁺].

### 6-(3-((tert-butyldiphenylsilyl)oxy)prop-1-yn-1-yl)quinoline

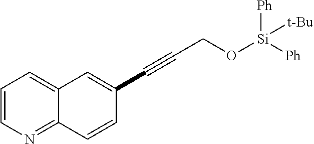

Yield 84.2 mg (95%) of 6-(3-((tert-butyldiphenylsilyl)oxy)prop-1-yn-1-yl)quinoline as a colorless solid (hexane/ethyl acetate: 80/20). ¹H NMR (500 MHz, CDCl₃) δ 7.08 (d, J=8.4 Hz, 2H), 6.58 (d, J=8.8 Hz, 2H), 3.63 (s, br, 2H); GC-MS, m/z: 178 [M⁺].

### 6-(quinolin-6-yl)hex-5-yn-1-yl 3-chlorobenzo[b]thiophene-2-carboxylate

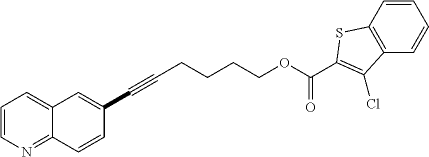

Yield 84.2 mg (95%) of 6-(quinolin-6-yl)hex-5-yn-1-yl 3-chlorobenzo[b]thiophene-2-carboxylate as a colorless solid (hexane/ethyl acetate: 80/20). ¹H NMR (500 MHz, CDCl₃) δ 7.08 (d, J=8.4 Hz, 2H), 6.58 (d, J=8.8 Hz, 2H), 3.63 (s, br, 2H); GC-MS, m/z: 178 [M⁺].

The procedures may be employed for the preparation of the compounds of the present invention. The starting materials and reagents used in preparing these compounds are either available from commercial suppliers such as the Aldrich Chemical Company (Milwaukee, Wis.), Bachem (Torrance, Calif.), Sigma (St. Louis, Mo.), as noted or are prepared by methods well known to a person of ordinary skill in the art, following procedures described in such references as Fieser and Fieser's Reagents for Organic Synthesis, vols. 1-17, John Wiley and Sons, New York, N.Y., 1991; Rodd's Chemistry of Carbon Compounds, vols. 1-5 and supps., Elsevier Science Publishers, 1989; Organic Reactions, vols. 1-40, John Wiley and Sons, New York, N.Y., 1991; March J.: Advanced Organic Chemistry, 4th ed., John Wiley and Sons, New York, N.Y.; and Larock: Comprehensive Organic Transformations, VCH Publishers, New York, 1989.

In some cases, protective groups may be introduced and finally removed. Suitable protective groups for amino, hydroxy, and carboxy groups are described in Greene et al., Protective Groups in Organic Synthesis, Second Edition, John Wiley and Sons, New York, 1991. Standard organic chemical reactions can be achieved by using a number of different reagents, for examples, as described in Larock: Comprehensive Organic Transformations, VCH Publishers, New York, 1989.

While a number of exemplary embodiments, aspects and variations have been provided herein, those of skill in the art will recognize certain modifications, permutations, additions and combinations and certain sub-combinations of the embodiments, aspects and variations. It is intended that the following claims are interpreted to include all such modifications, permutations, additions and combinations and certain sub-combinations of the embodiments, aspects and variations are within their scope.

The entire disclosures of all documents cited throughout this application are incorporated herein by reference.

What is claimed is:

1. A nanoparticle complex comprising:
a) one or more transition metal salts, or a combination of the transition metal salts;
b) an iron salt; and
c) a residual element of a reducing agent;
wherein the nanoparticle complex is obtained by:
i) a reaction of the reducing agent with the one or more transition metal salts;
ii) a reaction of the reducing agent with the one or more transition metal salts and the iron salt;
iii) a reaction of the reducing agent with a combination of the transition metal salts; or
iv) a reaction of the reducing agent with a combination of the transition metal salts and the iron salt.

2. A nanoparticle complex prepared by a process comprising of:
a) providing one or more transition metal salts or a combination of the transition metal salts;
b) contacting the one or more transition metal salts or a combination of the transition metal salts with an iron salt to form a mixture of salts; and
c) contacting the mixture of salts with a reducing agent under conditions sufficient to form the reduced nanoparticle complex.

3. A composition for the reduction of an organic compound comprising a nitro group to form an organic compound comprising an amine group, the composition comprising:
a) one or more transition metal salts, or a combination of the transition metal salts;
b) an iron salt;
c) a reducing agent; and
d) a first organic solvent.

4. The composition of claim 1, wherein the one or more transition metal salts, or a combination of the transition metal salts is selected from the group consisting of Fe-ppm Pd (Fe—Pd NPs), Fe-ppm Ni (Fe—Ni NPs) and Fe-ppm Pd+Ni NPs (Fe—Pd—Ni NPs).

5. The composition of claim 1, further comprising a reaction medium selected from a group consisting of one or more surfactants and water, optionally further comprising a second organic solvent or mixtures of solvent, as a co-solvent.

6. The composition of claim 1, wherein the organic compound is selected from the group consisting of an aliphatic, aromatic, heteroaromatic or heterocyclic compound.

7. The composition of claim 1, wherein the transition metal salt is a nickel salt, copper salt or a palladium salt, or combinations thereof.

8. The composition of claim 7, wherein the nickel salt is selected from the group consisting of NiCl₂, NiCl₂.6H₂O, NiCl₂.xH₂O, Ni(acac)₂, NiBr₂, NiBr₂.3H₂O, NiBr₂.xH₂O, Ni(acac)₂.4H₂O and Ni(OCOCH₃)₂.4H₂O; or other Ni(0-IV) species, such as Ni(II) species.

9. The composition of claim 7, wherein the palladium salt is selected from the group consisting of Pd(OAc)₂, PdCl₂, PdI₂, PdBr₂, Pd(CN)₂, Pd(NO₃)₂ and PdSO₄; or any Pd(0-IV) species, such as a Pd(II) species.

10. The composition of claim 7, wherein the copper salt is selected from the group consisting of CuBr, CuCl, Cu(NO₃)₂, Cut CuSO₄, CuOAc, CuSO₄ 5 H₂O, Cu/C, Cu(OAc)₂, CuOTf.C₆H₆ (OTf is trifluoromethanesulfonate) and [Cu(NCCH₃)₄][LPF₆].

11. The composition of claim 1, wherein the iron salt has a purity of less than 99.999% and the iron salt is doped with a palladium salt or a nickel salt, or a combination thereof, at 5,000 ppm, 3,000 ppm, 1,000 ppm, 500 ppm, 300 ppm, 200 ppm, 100 ppm, 90 ppm or 80 ppm or less.

12. The composition of claim 1, wherein the source of iron is selected from the group consisting of FeCl₃ or a Fe(II) or Fe(III) salts.

13. The composition of claim 5, wherein the surfactant is selected from the group consisting of TPGS-350-M, TPGS-550-M, TPGS-750-M, TPGS-1,000-M, TPGS-2000-M, Triton X-100, TPGS (polyoxyethanyl-a-tocopheryl succinate), TPGS-400-1000 (D-alpha-tocopheryl polyethylene glycol 400-1000 succinate), wherein the tocopheryl is the natural tocopherol isomer or the un-natural tocopherol isomer; Nok, Pluronic, Poloxamer 188, Polysorbate 80, Polysorbate 20, Vit E-TPGS, Solutol HS 15, PEG-40 Hydrogenated castor oil (Cremophor RH40), PEG-35 Castor oil (Cremophor EL), Triton X-100, all Brij surfactants, ionic surfactants (e.g., SDS), PEG-8-glyceryl capylate/caprate (Labrasol), PEG-32-glyceryl laurate (Gelucire 44/14), PEG-32-glyceryl palmitostearate (Gelucire 50/13); Polysorbate 85, Polyglyceryl-6-dioleate (Caprol MPGO), Mixtures of high and low HLB emulsifiers; Sorbitan monooleate (Span 80), Capmul MCM, Maisine 35-1, Glyceryl monooleate, Glyceryl monolinoleate, PEG-6-glyceryl oleate (Labrafil M 1944 CS), PEG-6-glyceryl linoleate (Labrafil M 2125 CS), Oleic acid, Linoleic acid, Propylene glycol monocaprylate (e.g. Capmul PG-8 or Capryol 90), Propylene glycol monolaurate (e.g., Capmul PG-12 or Lauroglycol 90), Polyglyceryl-3 dioleate (Plurol Oleique CC497), and Polyglyceryl-3 diisostearate (Plurol Diisostearique), or combinations thereof.

14. The composition of claim 1, wherein the reducing agent is selected from the group consisting of a Grignard reagent or a hydride reagent.

15. The composition of claim 14, wherein the Grignard reagent is selected from the group consisting of MeMgCl, EtMgCl, PrMgCl, BuMgCl, vinylMgCl, PhMgCl, MeMgBr, EtMgBr, PrMgBr, BuMgBr, vinylMgBr and PhMgBr, or a mixture of two or more Grignard reagents.

16. The composition of claim 14, wherein the reducing agent is selected from the group consisting of NaBH₄, LiBH₄, KBH₄, NaBH₄—KCl, LiAlH₄, LiAlH(OEt)₃, LiAlH(OMe)₃, LiAlH(O-tBut)₃, sodium bis(2-methoxyethoxy)aluminum hydride (Red-Al), LiBHEt₃, NaBH₃CN, BH₃ and diisobutylaluminum hydride (DIBAL-H or iBu₂AlH); or any silanes; or dihydrogen formate or ammonium formate.

17. The composition of claim 5, wherein the solvent or cosolvent is selected from the group consisting of acetone, THF, DMF, toluene, xylenes, 2-methyl-THF, diethyl ether, 1,4-dioxane, acetonitrile, MTBE, PEG, MPEG, MeOH, EtOH, PrOH, i-PrOH, nBuOH, sBuOH, i-PrOAc and ethyl acetate and mixtures thereof, wherein the solvent or co-solvent is present in 1-3% vol/vol or from about 0.01-50% vol/vol relative to water.

18.-39. (canceled)
